(19) United States
(12) Patent Application Publication
(10) Pub. No.: US 2022/0245527 A1
(43) Pub. Date: Aug. 4, 2022

(54) TECHNIQUES FOR ADAPTIVE QUANTIZATION LEVEL SELECTION IN FEDERATED LEARNING

(71) Applicant: QUALCOMM Incorporated, San Diego, CA (US)

(72) Inventors: Chang-Sik Choi, Hillsborough, NJ (US); Taesang Yoo, San Diego, CA (US); Kapil Gulati, Belle Mead, NJ (US); Junyi Li, Franklin Park, NJ (US)

(21) Appl. No.: 17/164,685

(22) Filed: Feb. 1, 2021

(51) Int. Cl. G06N 20/20; G06N 5/04; H04L 12/24

(52) U.S. Cl. CPC G06N 20/20; H04L 41/16; G06N 5/04

(57) ABSTRACT

Methods, systems, and devices for wireless communications are described. To support adaptive quantization level selection in federated learning, a server may cause a base station to transmit an indication of a quantization level for a user equipment (UE) to use to compress gradient data output by a machine learning model. For example, the server may determine, for each UE of a set of UEs, a respective quantization level for respective gradient data that is output by a respective machine learning model at each UE. The server may transmit, to each UE via one or more base stations, first information for use as an input in the respective machine learning model and an indication of the respective quantization level. A UE may receive the first information and the indication and may transmit, to the server, compressed gradient data that is generated based on (e.g., using) the indicated quantization level.

### FIELD OF TECHNOLOGY

The following relates to wireless communications, including techniques for adaptive quantization level selection in federated learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support techniques for adaptive quantization level selection in federated learning. Generally, the described techniques provide for ensuring global convergence of and reducing latency of generating a global machine learning model using federated learning techniques by adaptively indicating quantization levels to use to compress gradient data. For example, training the global machine learning model may include multiple iterations of a server transmitting, via a base station, information (e.g., estimates, weights, or parameters corresponding to the current global machine learning model) to a set of user equipments (UEs) for updating parameters of a respective local machine learning model and receiving, from each UE, gradient data that is generated using the information and is compressed according to some quantization level.

For each iteration, the server may determine a respective quantization level for each UE and may transmit (via the base station) an indication of the respective quantization level to each UE along with (e.g., in a same message as, in a different message as) the information for updating the parameters. In some examples, the server or the base station or both may determine a quantization level for a UE based on a channel condition (e.g., a link budget, a channel bandwidth, a channel quality, or some other channel condition) between the server or the base station or both and the UE. For example, higher link budgets or better channel conditions may correspond to higher data rates and thus, a shorter time for the UE to transmit gradient data. Accordingly, the server or the base station or both may select and indicate higher quantization levels for UEs having relatively better channel conditions and vice versa. Each UE may receive the information and the indication of the respective quantization level and may compress gradient data output by a respective machine learning model according to the indicated quantization level. Then, each UE may transmit the compressed gradient data to the server or the base station or both. In some examples, a UE may transmit a capability message to the server or the base station or both that indicates a set of quantization levels supported by the UE, and the server or the base station or both may select and indicate, at each iteration, quantization levels from the set of supported quantization levels for the UE to use.

A method for wireless communication at a UE is described. The method may include receiving first information for updating parameters of a machine learning model, receiving an indication of a quantization level for gradient data output by the machine learning model, and transmitting compressed gradient data that is generated based on the gradient data output by the machine learning model and the quantization level, where the gradient data output by the machine learning model is based on updating the machine learning model using the first information.

An apparatus for wireless communication at a UE is described. The apparatus may include a processor, memory coupled with the processor, and instructions stored in the memory. The instructions may be executable by the processor to cause the apparatus to receive first information for updating parameters of a machine learning model, receive an indication of a quantization level for gradient data output by the machine learning model, and transmit compressed gradient data that is generated based on the gradient data output by the machine learning model and the quantization level, where the gradient data output by the machine learning model is based on updating the machine learning model using the first information.

Another apparatus for wireless communication at a UE is described. The apparatus may include means for receiving first information for updating parameters of a machine learning model, means for receiving an indication of a quantization level for gradient data output by the machine learning model, and means for transmitting compressed gradient data that is generated based on the gradient data output by the machine learning model and the quantization level, where the gradient data output by the machine learning model is based on updating the machine learning model using the first information.

A non-transitory computer-readable medium storing code for wireless communication at a UE is described. The code may include instructions executable by a processor to receive first information for updating parameters of a machine learning model, receive an indication of a quantization level for gradient data output by the machine learning model, and transmit compressed gradient data that is generated based on the gradient data output by the machine learning model and the quantization level, where the gradient data output by the machine learning model is based on updating the machine learning model using the first information.

Some examples of the method, apparatuses, and non-transitory computer-readable medium described herein may further include operations, features, means, or instructions for compressing the gradient data output by the machine learning model based on the quantization level, where the transmitting of the compressed gradient data may be based on the compressing of the gradient data.

Some examples of the method, apparatuses, and non-transitory computer-readable medium described herein may further include operations, features, means, or instructions for receiving second information for updating the parameters of the machine learning model based on the transmitting of the compressed gradient data, receiving a second indication of a second quantization level for second gradient data output by the machine learning model, the second quantization level based on a duration associated with the communicating of the compressed gradient data, and transmitting second compressed gradient data that may be generated based on the second gradient data output by the machine learning model and the second quantization level, where the second gradient data output by the machine learning model may be based on updating the machine learning model using the second information.

In some examples of the method, apparatuses, and non-transitory computer-readable medium described herein, the quantization level may be associated with a set of UEs that includes the UE and the second quantization level may be specific to the UE.

Some examples of the method, apparatuses, and non-transitory computer-readable medium described herein may further include operations, features, means, or instructions for transmitting a capability message indicating a set of quantization levels supported by the UE, where the set of quantization levels includes the quantization level for the gradient data output by the machine learning model.

Some examples of the method, apparatuses, and non-transitory computer-readable medium described herein may further include operations, features, means, or instructions for transmitting a second indication of a time at which the gradient data may be output by the machine learning model and transmitting a third indication of the quantization level used to compress the gradient data output by the machine learning model.

In some examples of the method, apparatuses, and non-transitory computer-readable medium described herein, the transmitting of the third indication of the quantization level may include operations, features, means, or instructions for transmitting a set of quantization levels for the gradient data output by the machine learning model, each quantization level of the set of quantization levels associated with a dimensional parameter of a set of dimensional parameters associated with the gradient data output by the machine learning model.

Some examples of the method, apparatuses, and non-transitory computer-readable medium described herein may further include operations, features, means, or instructions for receiving a set of quantization levels that includes the quantization level, where the indication of the quantization level identifies the quantization level from the set of quantization levels that may be for the UE.

In some examples of the method, apparatuses, and non-transitory computer-readable medium described herein, the quantization level may be based on a bandwidth of a channel for transmitting the compressed gradient data, a link budget associated with the UE, or a combination thereof.

In some examples of the method, apparatuses, and non-transitory computer-readable medium described herein, the machine learning model includes a federated learning model associated with a set of UEs including the UE, and each UE of the set of UEs may be associated with a unique dataset of the machine learning model.

A method for wireless communication at a server is described. The method may include determining, for a UE of a set of UEs, a quantization level for gradient data output by a machine learning model implemented by the UE, transmitting, to the UE, first information for updating parameters of the machine learning model and an indication of the quantization level for the gradient data output by the machine learning model, and receiving, from the UE, compressed gradient data based on the transmitting of the first information and the indication of the quantization level.

An apparatus for wireless communication at a server is described. The apparatus may include a processor, memory coupled with the processor, and instructions stored in the memory. The instructions may be executable by the processor to cause the apparatus to determine, for a UE of a set of UEs, a quantization level for gradient data output by a machine learning model implemented by the UE, transmit, to the UE, first information for updating parameters of the machine learning model and an indication of the quantization level for the gradient data output by the machine learning model, and receive, from the UE, compressed gradient data based on the transmitting of the first information and the indication of the quantization level.

Another apparatus for wireless communication at a server is described. The apparatus may include means for determining, for a UE of a set of UEs, a quantization level for gradient data output by a machine learning model implemented by the UE, means for transmitting, to the UE, first information for updating parameters of the machine learning model and an indication of the quantization level for the gradient data output by the machine learning model, and means for receiving, from the UE, compressed gradient data based on the transmitting of the first information and the indication of the quantization level.

A non-transitory computer-readable medium storing code for wireless communication at a server is described. The code may include instructions executable by a processor to determine, for a UE of a set of UEs, a quantization level for gradient data output by a machine learning model implemented by the UE, transmit, to the UE, first information for updating parameters of the machine learning model and an indication of the quantization level for the gradient data output by the machine learning model, and receive, from the UE, compressed gradient data based on the transmitting of the first information and the indication of the quantization level.

Some examples of the method, apparatuses, and non-transitory computer-readable medium described herein may further include operations, features, means, or instructions for calculating a duration associated with the communicating of the compressed gradient data, determining a second quantization level for second gradient data output by the machine learning model based on the duration satisfying a threshold duration, transmitting, to the UE, second information for updating the parameters of the machine learning model and a second indication of the second quantization level, and receiving, from the UE, second compressed gradient data based on the transmitting of the second information and the second indication of the second quantization level.

In some examples of the method, apparatuses, and non-transitory computer-readable medium described herein, the duration corresponds to a second duration between transmitting the first information and receiving the compressed gradient data.

In some examples of the method, apparatuses, and non-transitory computer-readable medium described herein, the quantization level may be common the set of UEs and the second quantization level may be specific to the UE.

Some examples of the method, apparatuses, and non-transitory computer-readable medium described herein may further include operations, features, means, or instructions for receiving, from the UE, a capability message indicating a set of quantization levels supported by the UE, where the set of quantization levels includes the quantization level for the gradient data output by the machine learning model.

Some examples of the method, apparatuses, and non-transitory computer-readable medium described herein may further include operations, features, means, or instructions for transmitting, to each UE of the set of UEs, the first information and a respective indication of a respective quantization level for respective gradient data output by the machine learning model and receiving, from each UE of the set of UEs, respective compressed gradient data based on the transmitting of the first information and the respective indication of the respective quantization level.

Some examples of the method, apparatuses, and non-transitory computer-readable medium described herein may further include operations, features, means, or instructions for determining second information for updating the parameters of the machine learning model based on a mean of the respective compressed gradient data received from each UE.

Some examples of the method, apparatuses, and non-transitory computer-readable medium described herein may further include operations, features, means, or instructions for combining the respective gradient data received from each UE to update a global machine learning model implemented by the server, where determining the second information may be based on the combining of the respective gradient data.

Some examples of the method, apparatuses, and non-transitory computer-readable medium described herein may further include operations, features, means, or instructions for receiving, from the UE, a second indication of a time at which the gradient data may be output by the machine learning model and receiving a third indication of the quantization level used to compress the gradient data output by the machine learning model.

In some examples of the method, apparatuses, and non-transitory computer-readable medium described herein, the receiving of the third indication of the quantization level may include operations, features, means, or instructions for receiving a set of quantization levels for the gradient data output by the machine learning model, each quantization level of the set of quantization levels associated with a dimensional parameter of a set of dimensional parameters associated with the gradient data output by the machine learning model.

Some examples of the method, apparatuses, and non-transitory computer-readable medium described herein may further include operations, features, means, or instructions for transmitting, to the UE, a set of quantization levels that includes the quantization level, where the indication of the quantization level identifies the quantization level from the set of quantization levels that may be for the UE.

In some examples of the method, apparatuses, and non-transitory computer-readable medium described herein, the quantization level may be based on a bandwidth of a channel for transmitting the compressed gradient data, a link budget associated with the UE, or a combination thereof.

In some examples of the method, apparatuses, and non-transitory computer-readable medium described herein, the machine learning model includes a federated learning model associated with the set of UEs, and each UE of the set of UEs may be associated with a unique dataset of the machine learning model.

### BRIEF DESCRIPTION OF THE DRAWINGS

FIG. 1 illustrates an example of a wireless communications system that supports techniques for adaptive quantization level selection in federated learning in accordance with aspects of the present disclosure.

FIG. 2 illustrates an example of a wireless communications system that supports techniques for adaptive quantization level selection in federated learning in accordance with aspects of the present disclosure.

FIG. 3 illustrates an example of a process flow that supports techniques for adaptive quantization level selection in federated learning in accordance with aspects of the present disclosure.

FIGS. 4 and 5 show block diagrams of devices that support techniques for adaptive quantization level selection in federated learning in accordance with aspects of the present disclosure.

FIG. 6 shows a block diagram of a communications manager that supports techniques for adaptive quantization level selection in federated learning in accordance with aspects of the present disclosure.

FIG. 7 shows a diagram of a system including a device that supports techniques for adaptive quantization level selection in federated learning in accordance with aspects of the present disclosure.

FIGS. 8 and 9 show block diagrams of devices that support techniques for adaptive quantization level selection in federated learning in accordance with aspects of the present disclosure.

FIG. 10 shows a block diagram of a communications manager that supports techniques for adaptive quantization level selection in federated learning in accordance with aspects of the present disclosure.

FIG. 11 shows a diagram of a system including a device that supports techniques for adaptive quantization level selection in federated learning in accordance with aspects of the present disclosure.

FIGS. 12 through 18 show flowcharts illustrating methods that support techniques for adaptive quantization level selection in federated learning in accordance with aspects of the present disclosure.

### DETAILED DESCRIPTION

Some wireless communications systems may include communication devices, such as a user equipment (UE) and a base station (e.g., an eNodeB (eNB), a next-generation NodeB or a giga-NodeB, either of which may be referred to as a gNB, or some other base station), that may support multiple radio access technologies (RATs). Examples of RATs include fourth generation (4G) systems, such as Long Term Evolution (LTE) systems, and fifth-generation (5G) systems, which may be referred to as new radio (NR) systems. In some examples, communication devices may utilize machine learning models (e.g., neural network based machine learning models, among others) in which one or more components (e.g., a transmitter, receiver, encoder, decoder, etc.) may be configured using machine learning. For example, machine learning model configurations at a transmitter may provide one or more of encoding, modulation, or precoding functions, and machine learning model configurations at a receiver may provide one or more of synchronization, channel estimation, detection, demodulation, or decoding functions.

In some examples, a server (via a base station) and a set of workers (e.g., UEs) may implement federated learning techniques to train machine learning models over a wireless communication system. Such techniques may include multiple iterations of the set of workers providing local gradient data generated using local models contained at each worker to the server for inclusion in a global model shared by the server and the set of workers. The server may aggregate the local gradient data received from the set of workers and may update the global model at the server (e.g., using gradient averaging). The server may then provide subsequent information (e.g., model estimates, model weights, model parameters) to the set of workers, which may in turn provide additional local gradient data. For example, the information may convey the weights and/or parameters of the current global model that was updated by the server based on the aggregated local gradient data. Federated learning models may provide relatively fast access to real-time or near-real-time data generated at the workers, which may allow for relatively fast training of the machine learning models. Further, such federated learning may consume relatively fewer radio resources and have lower delay, due to multiple workers providing respective local gradient data. Additionally, as the workers may not provide raw data, such federated learning techniques may provide enhanced privacy because information stays at the workers and is not shared between workers or with the server.

Some machine learning models, however, use a relatively large quantity of layers and associated nodes resulting in a relatively large quantity of data to be communicated as part of machine learning procedures. For example, some neural networks may include millions of dimensional parameters after training. In order to efficiently communicate such training information, a worker may compress the gradient data according to a quantization level (e.g., quantization level of 32 bits, 64, bits, 128 bits, or some other quantity of bits). In some cases, the time it takes for a worker to transmit quantized or compressed gradient data may be based on one or more conditions of the channel between the worker and the server (e.g., a link budget, a channel bandwidth, a channel quality, or some other channel condition). For example, a higher link budget may correspond to faster data rates and thus, less time to transmit the compressed gradient data. In some cases, different channel conditions of the air interface between workers and the base station may result in relatively large latency differences between workers transmitting the compressed gradient data to the server. These latency differences may increase latency associated with training the global model, for example, because the server may wait to receive the compressed gradient data from each worker (via the air interface and the base station) before transmitting updated information related to the global model. Additionally, in some examples, workers may continue to train local models using local datasets that are unique to each worker while waiting for the updated information, which in some cases may cause the convergence to local optima rather than a global optima.

Techniques, systems, and devices are described herein to adaptively select and indicate quantization levels for gradient data output by local models to reduce latency associated with training a global model using federated learning techniques and to ensure global convergence of the global model. For example, a server may determine a quantization level for a worker of a set of workers to use to compress gradient data output by a local model of the worker. The server may transmit (via the base station) information (e.g., estimates, weights, or parameters corresponding to a current global model) to the worker to update parameters (e.g., estimates or weights) of the local model of the worker and may transmit an indication of the quantization level. The worker may update the local model, compute gradient data using the updated local model, and compress the gradient data according to the indicated quantization level. Then, the worker may transmit the compressed gradient data to the server. The server may determine a respective quantization level for each worker of the set of workers and may transmit an indication of the respective quantization level to each worker. Accordingly, the server may receive compressed gradient data from each worker that is compressed according to the respectively indicated quantization level.

The server may select and indicate the quantization level to the worker for each iteration in training the global model. Accordingly, if channel conditions change between the worker and the server, the server may select a quantization level such that the worker may transmit the compressed gradient level within some finite time. For example, if channel conditions worsen, thereby resulting in lower data rates, the server may select a lower quantization level (e.g., corresponding to transmitting fewer bits) such that the worker may transmit the compressed gradient data within the finite time. In this way, the server may reduce latency associated with training the global model by ensuring the gradient data will be received from each worker within a desired time. Additionally, the server may ensure that updated information related to the global model is transmitted within the finite time to ensure that the global model converges to a global optima.

Aspects of the subject matter described in this disclosure may be implemented to realize one or more of the following potential improvements, among others. The techniques employed by the UE and the base station may provide benefits and enhancements to the operation of the UE and the base station. For example, operations performed by the UE and the base station may provide improvements to federated learning implementations. In some examples, a server (via a base station) indicating a quantization level for a UE to use to compress gradient data at each iteration of training a global model may ensure convergence to a global optima of the global model and may reduce latency associated with training the global model using federated learning techniques. In some other examples, the server (via the base station) indicating the quantization level may provide improvements to data rates, power consumption, and spectral efficiency, among other benefits.

Aspects of the disclosure are initially described in the context of wireless communications systems. Aspects of the disclosure are additionally described in the context of a process flow. Aspects of the disclosure are further illustrated by and described with reference to apparatus diagrams, system diagrams, and flowcharts that relate to techniques for adaptive quantization level selection in federated learning.

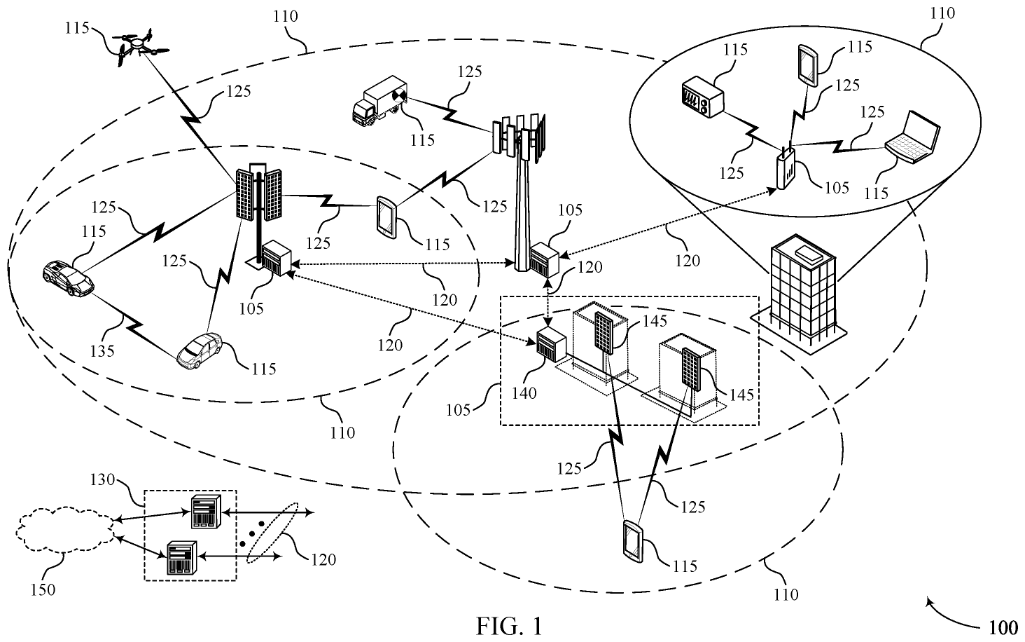

FIG. 1 illustrates an example of a wireless communications system 100 that supports techniques for adaptive quantization level selection in federated learning in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The quantity of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The wireless communications system 100 may support federated learning to train machine learning models. For example, a set of UEs 115 may iteratively provide local gradient data that is generated using local models to a server over an air interface via a base station 105 for inclusion in a global model shared by the server and the set of UEs 115. In some cases, the server may integrated with one or more base stations 105. In some cases, the server may be separate from one or more base stations 105. The server may aggregate the local gradient data received from the set of UEs 115 and may update the global model at the server at each iteration in training the global model. In some examples, to efficiently communicate the gradient data, UEs 115 of the set of UEs 115 may compress the gradient data according to some quantization level.

To reduce latency associated with training the global model and to ensure global convergence of the global model, the server may adaptively select and indicate quantization levels for each UE 115 to use to compress respective gradient data. For example, the server may determine a quantization level for a UE 115 of the set of UEs 115 to use to compress gradient data output by a local model of the UE 115. In some examples, the UE 115 may transmit a capability message to the server (via the base station 105) indicating a set of quantization levels supported by the UE 115. Here, the server may select the quantization level from the set of supported quantization levels.

The server via the base station 105 may transmit information (e.g., estimates, weights, and/or parameters corresponding to the current global model) to the UE 115 to update parameters or estimates of the local model of the UE 115 (e.g., to update the local model to match the current global model) and may transmit an indication of the quantization level. The UE 115 may update the local model, compute gradient data using the updated local mode, and compress the gradient data according to the indicated quantization level. Then, the UE 115 may transmit the compressed gradient data to the server via the base station 105. In some examples, the server may select the quantization level such that UE 115 may transmit the compressed gradient data within a finite time. In this way, the server may reduce latency associated with training the global model by ensuring the gradient data will be received from each UE 115 within a desired time. Additionally, the server may ensure that updated information related to the global model is transmitted within the finite time to ensure that the global model converges to a global optima.

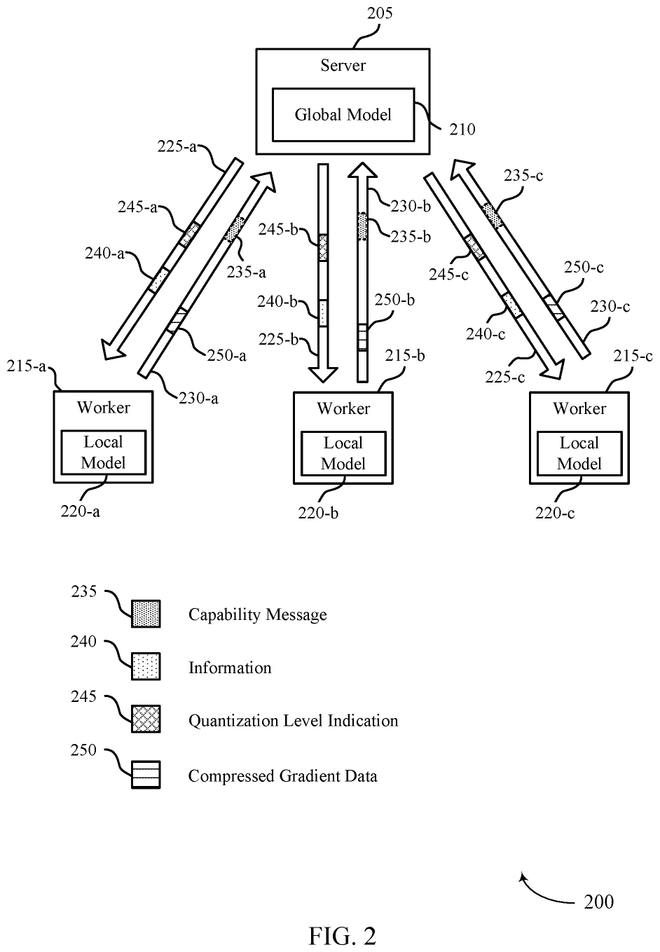

FIG. 2 illustrates an example of a wireless communications system 200 that supports techniques for adaptive quantization level selection in federated learning in accordance with aspects of the present disclosure. In some examples, the wireless communications system 200 may implement aspects of the wireless communications system 100. For example, the wireless communications system 200 may include a server 205 and workers 215-a, 215-b, and 215-c, which may be examples of a base station 105 and a UE 115 as described with reference to FIG. 1, respectively. In some examples, the wireless communications system 200 may support one or more RATs including 4G systems such as LTE systems, LTE-A systems, or LTE-A Pro systems, 5G systems which may be referred to as NR systems, or a combination of these or other RATs. In some cases, the server 205 and the workers 215-a, 215-b, and 215-c may implement a quantization level indication 245 to support adaptive quantization level selection in federated learning.

For illustrative purposes, FIG. 2 depicts the wireless communications system 200 as including three workers 215, however, the principles disclosed herein may be adapted and applied to include any quantity of workers 215.

The server 205 may communicate with the workers 215 via downlink communication links 225 and uplink communication links 230. For example, the server 205 may transmit downlink messages to the workers 215-a, 215-b, and 215-c via downlink communication links 225-a, 225-b, and 225-c, respectively. Additionally, the workers 215-a, 215-b, and 215-c may transmit uplink messages to the server 205 via uplink communication links 230-a, 230-b, and 230-c, respectively.

The wireless communications system 200 may support federated learning techniques to train machine learning models. For example, the server 205 may include a global model 210, which may be an example of a machine learning model shared by the server 205 and a set of workers 215 (e.g., workers 215-a, 215-b, and 215-c). Each of the workers 215 may include a local model 220-b, which may correspond to a version of the global model 210 at a given time. For example, training the global model 210 may include multiple iterations of the workers 215 providing gradient data output from respective local models 220 to the server 205, the server 205 combining the gradient data to update the global model 210, and the server 205 providing information to the workers 215 to update the local models 220 to the updated global model, among other operations. Accordingly, the local models 220 may correspond to the global model 210 at the current iteration in training the global model 210.

In some cases, to efficiently transmit gradient data to the server 205, the workers 215 may compress the gradient data according to some quantization level (e.g., quantization level of 32 bits, 64, bits, 128 bits, . . . , 1024 bits, or some other quantity of bits). However, channel conditions (e.g., link budgets, channel bandwidths, channel qualities, or other channel conditions) between the workers 215 and the server 205 may differ. For example, the worker 215-a may have relatively better channel conditions (e.g., higher link budget, channel bandwidth, channel quality, or some other channel condition) than the worker 215-b. Accordingly, if the worker 215-a and the worker 215-b were to transmit a same quantity of gradient compressed according to a same quantization level, the worker 215-a may transmit the compressed gradient data faster than the worker 215-b may transmit the compressed gradient data. In some cases, differences in latency to transmit the compressed gradient data may be relatively large and may increase latency associated with training the global model 210, and in some cases, may cause the global model 210 to converge to local optima.

To reduce latency associated with training the global model 210 and to ensure global convergence of the global model 210, the server may adaptively select and indicate quantization levels to the workers 215. For example, for a given iteration in training the global model 210, the server 205 may transmit information 240 for updating parameters (e.g., estimates or weights) of a local model 220 to each of the workers 215. For example, the server 205 may transmit information 240-a to worker 215-a, information 240-b to worker 215-b, and information 240-c to worker 215-c. In response to receiving information 240, a worker 215 may update parameters of a respective local model 220. For example, information 240 may include weights and/or dimensional parameters corresponding to the current iteration of the global model 210. Accordingly, the worker 215-a, for example, may update the local model 220-a to correspond to the current iteration of the global model 210. However, while the local models 220 of each worker 215 may correspond to the current iteration of the global model 210, each worker 215 may have a unique local dataset that it inputs into a respective local model 220. Accordingly, gradient data that is output by each local model 220 may be different.

Additionally, the server 205 may determine, for each worker 215, a quantization level for gradient data output by a respective local model 220. In some examples, the server 205 may determine a respective quantization level based on channel conditions between the server 205 and a respective worker 210. For example, if channel conditions between the worker 215-a and the server 205 are relatively high, the server 205 may select a relatively high quantization level for the worker 215-a to use to compress gradient data output by the local model 220-a. In some examples, the server 205-a may select the quantization level from a set of quantization levels supported by a worker 215. For example, each worker 215 may support a different set of quantization levels. In some examples, each worker 215 may transmit a capability message 235 (e.g., capability messages 235-a, 235-b, and 235-c) to the server 205 that indicates the set of quantization levels supported by the worker 215. Here, the server 205, for each worker 215, may select a quantization level from the set of quantization levels supported by the worker 215.

The server 205 may transmit a respective quantization level indication 245 to each of the workers 215 based on determining the respective quantization level. For example, the server 205 may transmit a quantization level indication 245-a to the worker 215-a that indicates a first quantization level, a quantization level indication 245-b to the worker 215-b that indicates a second quantization level, and a quantization level indication 245-c to the worker 215-c that indicates a third quantization level.

Each worker 215 may compress gradient data according to the indicated quantization level. For example, the worker 215-a may compress gradient data output by the local model 220-a according to the first quantization level, the worker 215-b may compress gradient data output by the local model 220-b according to the second quantization level, and the worker 215-c may compress gradient data output by the local model 220-c according to the third quantization level. In this way, each worker 215 may independently compress gradient data according to a quantization level that is suitable for the channel conditions between the server 205 and the worker 215 (e.g., that may allow each worker 215 to transmit the gradient data within some finite amount of time). After compressing the gradient data, each worker 215 may transmit compressed gradient data 250 (e.g., compressed gradient data 250-a, 250-b, and 250-c) to the server 205.

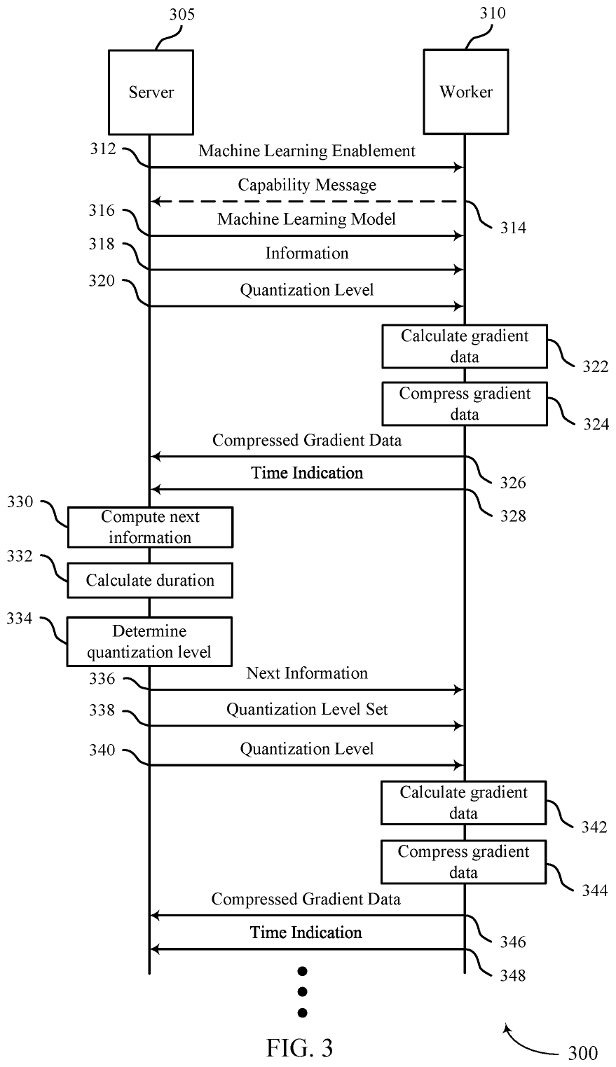

FIG. 3 illustrates an example of a process flow 300 that supports techniques for adaptive quantization level selection in federated learning in accordance with aspects of the present disclosure. In some examples, the process flow 300 may implement aspects of the wireless communications systems 100 and 200 as described with reference to FIGS. 1 and 2, respectively. For example, the process flow 300 may be implemented by a server 305, which may be an example of a base station 105 or a server 205 as respectively described with reference to FIGS. 1 and 2, and a worker 310, which may be an example of a UE 115 or a worker 215 as respectively described with reference to FIGS. 1 and 2. The process flow 300 may be implemented by the server 305 and the worker 310 to support adaptive quantization level selection and indication in federated learning. The process flow 300 may further be implemented by the server 305 and the worker 310 to potentially reduce latency associated with training a machine learning model (e.g., a global model shared by the server 305 and the worker 310) using federated learning techniques and ensuring global convergence of the machine learning model (e.g., based on selecting quantization levels based on channel conditions between the server 305 and the worker 310), among other benefits.

In the following description of the process flow 300, the operations between the server 305 and the worker 310 may be communicated in a different order than the example order shown, or the operations performed by the server 305 and the worker 310 may be performed in different orders or at different times. Some operations may also be omitted from the process flow 300, and other operations may be added to the process flow 300. For illustrative purposes, FIG. 3 depicts the process flow 300 as being implemented by the server 305 and the worker 310, however, the principles disclosed herein may be adapted and applied such that the process flow 300 may be implemented by the server 305 and any quantity of workers 310.

At 312, the server 305 may transmit a machine learning enablement message to the worker 310. The machine learning enablement message may indicate the worker 310 to enable federated learning. In some examples, the server may transmit the machine learning enablement message to a set of workers 310 that includes the worker 310. The federated learning may be used to train a machine learning model shared by the server 305 and the set of workers, which may be referred to as a global model. The global model may include a quantity of layers and a quantity of nodes within each layer. Training the global model may include iteratively updating weights and/or dimensional parameters associated with the layers and node by combining, at the server 305, gradient data associated with the dimensional parameters that is received from the set of workers.

At 314, the worker 310 may optionally transmit a capability message to the server 305 that indicates a set of quantization levels supported by the worker 310. For example, the quantization levels supported by (e.g., that may be used the worker 310 to compress gradient data) the worker 310 may be a subset of a set of quantization levels supported by the server 305. The worker 310 may transmit the capability message to the server 305 to prevent the server from selecting and indicating a quantization level during the federated learning that is not supported by the worker 310.

At 316, the server 305 may transmit a machine learning model to the worker 310 to be used by the worker 310. For example, the machine learning model may include one or more functions to be executed at the worker 310 to calculate gradient data. In some examples, the machine learning model may be referred to as a local model.

At 318, the server 305 may transmit, to the worker 310, information for updating parameters (e.g., estimates or weights) of the local model at a first time. In some cases, the information may be a first estimate (x_i) for the machine learning model at the worker 310. For example, the information may include the weights and/or parameters corresponding to the current global model.

At 320, the server 305 may transmit, to the worker 310, a first indication of a first quantization level for gradient data output by the machine learning model. In some examples, the first quantization level may be associated with the set of workers 310. For example, for the first iteration of the federated learning, the first quantization level may be a same quantization level for some or all workers 310 participating in the federated learning (e.g., for each worker 310 of the set of worker 310). In some cases, the server 305 may transmit the information and the first indication of the first quantization level in a same message. In some other cases, the server 305 may transmit the information and the first indication of the first quantization level in different messages. In some cases, the quantization level may indicate a quantization used to compress data output by a machine learning model into a form that is more easily communicated over an air interface to the server 305 via a base station. In some cases, the quantization level may indicate a quantization used by various aspects of the machine learning model implemented at the worker 310. In some cases, the quantization level may be used by both the machine learning model and the communications interface.

At 322, the worker 310 may calculate gradient data using the local model. For example, the worker 310 may update parameters (e.g., estimates or weights) of the local model at the worker 310 using the information for updating the parameters. In some examples, updating parameters of the local model may include the worker 310 updating the local model to match the current global model. The worker 310 may generate or determine a local dataset and may calculate gradient data using the updated local model and the local dataset. For example, the worker 310 may input the local dataset into the updated local model which then outputs the gradient data. In some examples, the gradient data may include one or more gradients corresponding to subsets of data of the local dataset. For example, the local model may be used to calculate (e.g., output) one or more gradients corresponding to the local dataset.

At 324, the worker 310 may compress the gradient data according to the first quantization level. In some examples, the worker 310 may compress each of the one or more calculated gradients according to the first quantization level. In some examples, the worker 310 may normalize the compressed gradient data to have a unit L2 norm.

At 326, the worker 310 may transmit the compressed gradient data to the server 305. In some examples, the worker 310 may transmit an indication of the quantization level used to compress the gradient data (e.g., the first quantization level).

At 328, the worker 310 may transmit an indication of a time at which the gradient data is output by the local model. In some examples, the time may be an absolute time (e.g., a time of day) or a relative time. In some cases, a relative time may be a duration between receiving the information, or the first indication of the first quantization level, or both, and outputting the gradient data.

At 330, the server 305 may compute next information (e.g., another estimate, such as x_1+1) related to the global model for a next iteration in training the global model. For example, the server 305 may receive compressed gradient data from each worker 310 of the set of workers 310, including the worker 310. The server 305 may update the weights and/or dimensional parameters of the global model based on the compressed gradient data, where the next information includes the updated weights and/or dimensional parameters. For example, the server 305 may compute the next information based on a mean of the compressed gradient data received from the set of workers 310. In some examples, the server 305 may compute the next information using the following equation:

xᵢ₊₁=xᵢ−η*mean(g)

where xᵢ₊₁ is the next information, xᵢ is the information of the current iteration, η is a step size of the global model, and g is the compressed gradient data received from the set of workers 310.

At 332, the server 305 may calculate a duration associated with communicating the compressed gradient data between the server 305 and the worker 310. For example, the server 305 may track a duration between transmitting the information and receiving the compressed gradient data from the worker 310. In some other examples, the server 305 may use the indication of the time at which the gradient is output by the local model to determine a duration for the worker 310 to transmit (e.g., and compress) the compressed gradient data. In some examples, the server 305 may calculate (e.g., and store) a respective duration associated with communicating the compressed gradient data between the server 305 and each worker 310 of the set of workers 310.

The duration may be based on one or more channel conditions (e.g., a link budget, a channel bandwidth, a channel quality, or some other channel condition) between the server 305 and the worker 310. For example, a higher link budget, channel bandwidth, channel quality, or a combination thereof, may correspond to faster data rates and thus, less time to transmit the compressed gradient data. Accordingly, a first worker 310 having relatively better channel conditions (e.g., higher link budget) than a second worker 310 may transmit a same quantity of compressed gradient data faster than the second worker 310.

At 334, the server 305 may determine a second quantization level for second gradient data output by the local model that corresponds to the next information. The server 305 may determine the second quantization level based on the duration. For example, the server 305 may compare the duration to a threshold duration. If the duration is less than (or equal to) to the threshold duration, the server 305 may determine that it received the compressed gradient data within some finite time (e.g., pre-configured or configured at the server 305). Accordingly, the server 305 may select a same or higher quantization level (e.g., from the set of quantization levels supported by the UE) for the second quantization level. Alternatively, if the duration is greater than the threshold duration, the server 305 may select a lower quantization level for the second quantization level such that the worker 310 may transmit the compressed gradient data within the finite time. In some examples, the threshold duration may change from iteration to iteration in training the global model. In some other examples, the threshold duration may remain constant from iteration to iteration. In some cases, the server 305 and worker 310 may re-use the first quantization level for subsequent iterations of the machine learning model. For example, if the channel conditions between the worker 310 and the server 305 are largely unchanged, the same quantization level may be used.

In some examples, the server 305 may determine a set of quantization levels for the second gradient data. For example, if the gradient data included multiple gradients, the server 305 may select a quantization level for each gradient of the second gradient data to be calculated by the worker 310.

Additionally, the server 305 may determine a respective quantization level (e.g., or respective set of quantization levels) for each worker 310 of the set of workers 310. For example, based on a respective duration, the server 305 may select a respective quantization level for each worker 310 of the set of workers 310. Each respective quantization level may be specific to the respective worker 310. For example, for each iteration after the first iteration, the server 305 may determine a quantization level that is specific to each worker 310.

At 336, the server 305 may transmit the next information (e.g., x_i+1) the worker 310 at a second time. Additionally, the server 305 may transmit the next information to the set of workers 310.

At 338, the server 305 may transmit a set of quantization levels to the worker 310 that includes the second quantization level.

At 340, the server 305 may transmit an indication of the second quantization level to the worker 310. In some examples, the indication may identify the second quantization level from the set of quantization levels transmitted at 338. In some examples, the indication may identify a subset of quantization levels of the set of quantization levels, for example, if the server 305 determined a set of quantization levels at 334, where the subset of quantization levels corresponds to the determined set of quantization levels. In some cases, the server 305 may transmit the next information, the set of quantization levels, and the indication of the second quantization level in any combination of one or more messages.

At 342, the worker 310 may update the local model using the next information and may calculate second gradient data using the updated local model. For example, the worker 310 may input the local dataset into the updated model which then outputs the second gradient data.

At 344, the worker 310 may compress the second gradient data according to the second quantization level. In some examples, if the second gradient data includes multiple gradients, the worker 310 may compress each gradient according to a corresponding quantization level of the subset of quantization levels.

At 346, the worker 310 may transmit the compressed second gradient data to the server 305. In some examples, the worker 310 may transmit an indication of each quantization level used to compress the gradient data. For example, the worker 310 may transmit an indication of the second quantization level. Additionally, or alternatively, the worker 310 may transmit a respective indication for each quantization level of the subset of quantization levels.

At 348, the worker may transmit an indication of a time at which the second gradient data is output by the local model. In some examples, the time may be an absolute time (e.g., a time of day) or a relative time. In some cases, a relative time may be a duration between receiving the next information, or the indication of the second quantization level, or both, and outputting the second gradient data.

The server 305 and the worker 310 may continue to train the global model using one or more of the above operations. For example, the server 305 and the worker 310 may repeat any combination of 330 through 348 to iteratively train and update the global model.

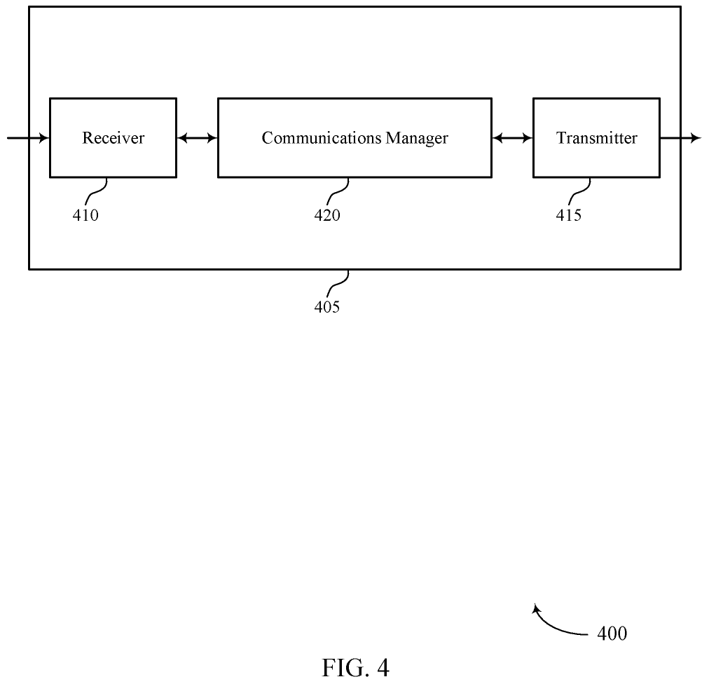

FIG. 4 shows a block diagram 400 of a device 405 that supports techniques for adaptive quantization level selection in federated learning in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for adaptive quantization level selection in federated learning). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for adaptive quantization level selection in federated learning). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for adaptive quantization level selection in federated learning as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for receiving first information for updating parameters of a machine learning model. The communications manager 420 may be configured as or otherwise support a means for receiving an indication of a quantization level for gradient data output by the machine learning model. The communications manager 420 may be configured as or otherwise support a means for transmitting compressed gradient data that is generated based on the gradient data output by the machine learning model and the quantization level, where the gradient data output by the machine learning model is based on updating the machine learning model using the first information.

By including or configuring the communications manager 420 in accordance with examples as described herein, the device 405 (e.g., a processor controlling or otherwise coupled to the receiver 410, the transmitter 415, the communications manager 420, or a combination thereof) may reduce processing resources and power consumption associated with federated learning procedures. For example, by transmitting compressed gradient data that is generated based on an indicated quantization level, the device 405 may reduce a time spent and a quantity of resources used to transmit the gradient data.

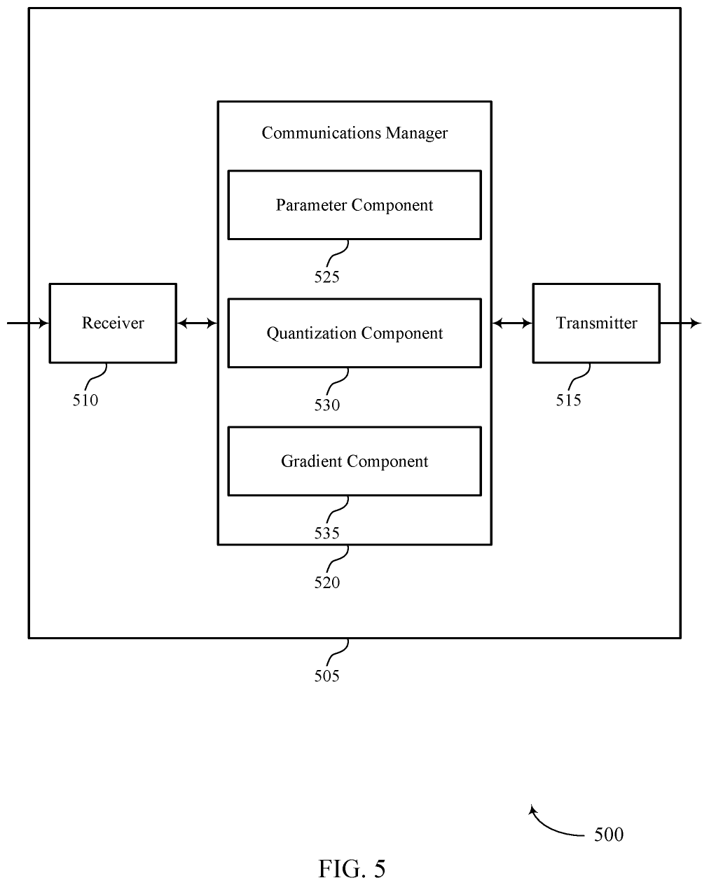

FIG. 5 shows a block diagram 500 of a device 505 that supports techniques for adaptive quantization level selection in federated learning in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for adaptive quantization level selection in federated learning). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for adaptive quantization level selection in federated learning). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for adaptive quantization level selection in federated learning as described herein. For example, the communications manager 520 may include a parameter component 525, a quantization component 530, a gradient component 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The parameter component 525 may be configured as or otherwise support a means for receiving first information for updating parameters of a machine learning model. The quantization component 530 may be configured as or otherwise support a means for receiving an indication of a quantization level for gradient data output by the machine learning model. The gradient component 535 may be configured as or otherwise support a means for transmitting compressed gradient data that is generated based on the gradient data output by the machine learning model and the quantization level, where the gradient data output by the machine learning model is based on updating the machine learning model using the first information.

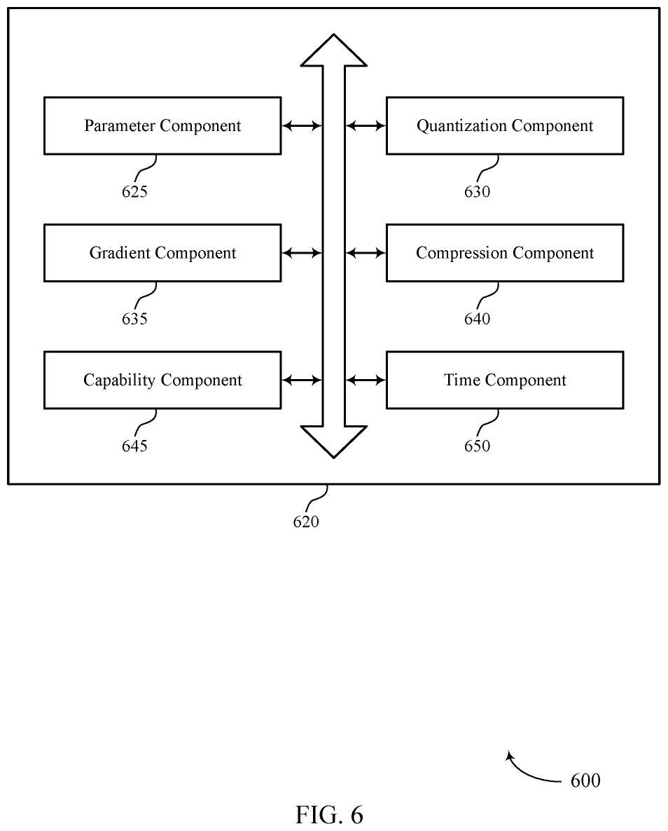

FIG. 6 shows a block diagram 600 of a communications manager 620 that supports techniques for adaptive quantization level selection in federated learning in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for adaptive quantization level selection in federated learning as described herein. For example, the communications manager 620 may include a parameter component 625, a quantization component 630, a gradient component 635, a compression component 640, a capability component 645, a time component 650, or any combination thereof. Each of these components may communicate, directly or indirectly, with one another (e.g., via one or more buses).

The communications manager 620 may support wireless communication at a UE in accordance with examples as disclosed herein. The parameter component 625 may be configured as or otherwise support a means for receiving first information for updating parameters of a machine learning model. The quantization component 630 may be configured as or otherwise support a means for receiving an indication of a quantization level for gradient data output by the machine learning model. The gradient component 635 may be configured as or otherwise support a means for transmitting compressed gradient data that is generated based on the gradient data output by the machine learning model and the quantization level, where the gradient data output by the machine learning model is based on updating the machine learning model using the first information.

In some examples, the compression component 640 may be configured as or otherwise support a means for compressing the gradient data output by the machine learning model based on the quantization level, where the transmitting of the compressed gradient data is based on the compressing of the gradient data.

In some examples, the parameter component 625 may be configured as or otherwise support a means for receiving second information for updating the parameters of the machine learning model based on the transmitting of the compressed gradient data. In some examples, the quantization component 630 may be configured as or otherwise support a means for receiving a second indication of a second quantization level for second gradient data output by the machine learning model, the second quantization level based on a duration associated with the communicating of the compressed gradient data. In some examples, the gradient component 635 may be configured as or otherwise support a means for transmitting second compressed gradient data that is generated based on the second gradient data output by the machine learning model and the second quantization level, where the second gradient data output by the machine learning model is based on updating the machine learning model using the second information.

In some examples, the quantization level is associated with a set of UEs that includes the UE. In some examples, the second quantization level is specific to the UE.

In some examples, the capability component 645 may be configured as or otherwise support a means for transmitting a capability message indicating a set of quantization levels supported by the UE, where the set of quantization levels includes the quantization level for the gradient data output by the machine learning model.

In some examples, the time component 650 may be configured as or otherwise support a means for transmitting a second indication of a time at which the gradient data is output by the machine learning model. In some examples, the quantization component 630 may be configured as or otherwise support a means for transmitting a third indication of the quantization level used to compress the gradient data output by the machine learning model.

In some examples, to support transmitting of the third indication of the quantization level, the quantization component 630 may be configured as or otherwise support a means for transmitting a set of quantization levels for the gradient data output by the machine learning model, each quantization level of the set of quantization levels associated with a dimensional parameter of a set of dimensional parameters associated with the gradient data output by the machine learning model.

In some examples, the quantization component 630 may be configured as or otherwise support a means for receiving a set of quantization levels that includes the quantization level, where the indication of the quantization level identifies the quantization level from the set of quantization levels that is for the UE.

In some examples, the quantization level is based on a bandwidth of a channel for transmitting the compressed gradient data, a link budget associated with the UE, or a combination thereof.

In some examples, the machine learning model includes a federated learning model associated with a set of UEs including the UE. In some examples, each UE of the set of UEs is associated with a unique dataset of the machine learning model.

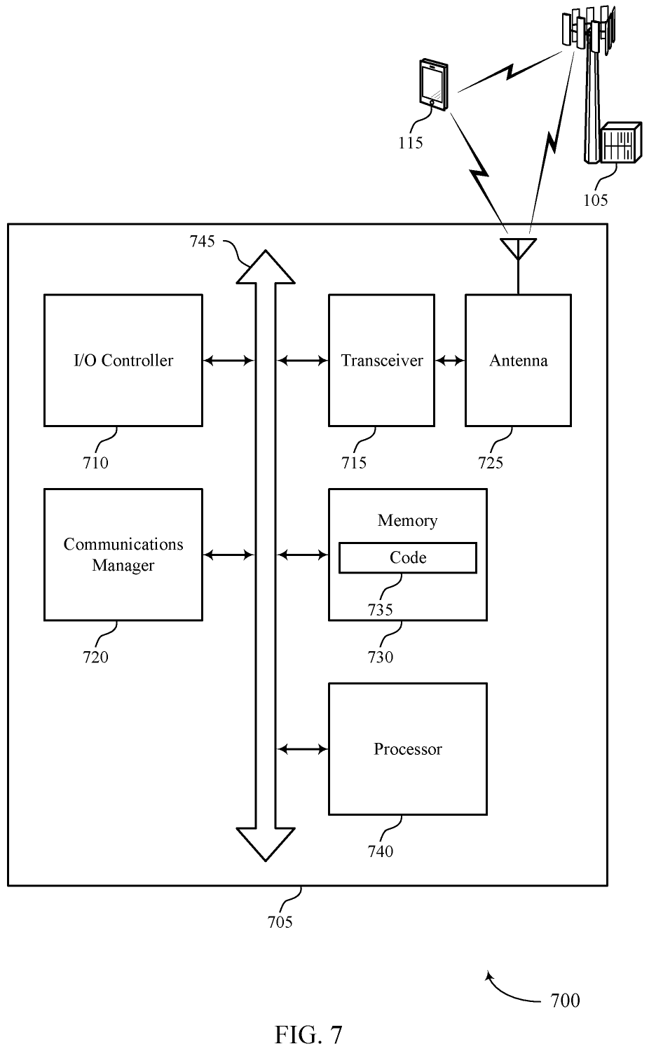

FIG. 7 shows a diagram of a system 700 including a device 705 that supports techniques for adaptive quantization level selection in federated learning in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for adaptive quantization level selection in federated learning). For example, the device 705 or a component of the device 705 may include a processor 740 and memory 730 coupled to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving first information for updating parameters of a machine learning model. The communications manager 720 may be configured as or otherwise support a means for receiving an indication of a quantization level for gradient data output by the machine learning model. The communications manager 720 may be configured as or otherwise support a means for transmitting compressed gradient data that is generated based on the gradient data output by the machine learning model and the quantization level, where the gradient data output by the machine learning model is based on updating the machine learning model using the first information.

By including or configuring the communications manager 720 in accordance with examples as described herein, the device 705 may provide improvements to federated learning techniques. For example, transmitting gradient data that is compressed according to an indicated quantization level may ensure convergence to a global optima of a global machine learning model and may reduce latency associated with training the global machine learning model using federated learning techniques. Additionally, transmitting gradient data that is compressed according to an indicated quantization level may promote improvements to efficiency and resource usage of federated learning operations and, in some examples, may promote spectral efficiency, reduce power consumption, improve coordination between the UE and a base station, and increase battery life, among other benefits.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for adaptive quantization level selection in federated learning as described herein, or the processor 740 and the memory 730 may be otherwise configured to perform or support such operations.

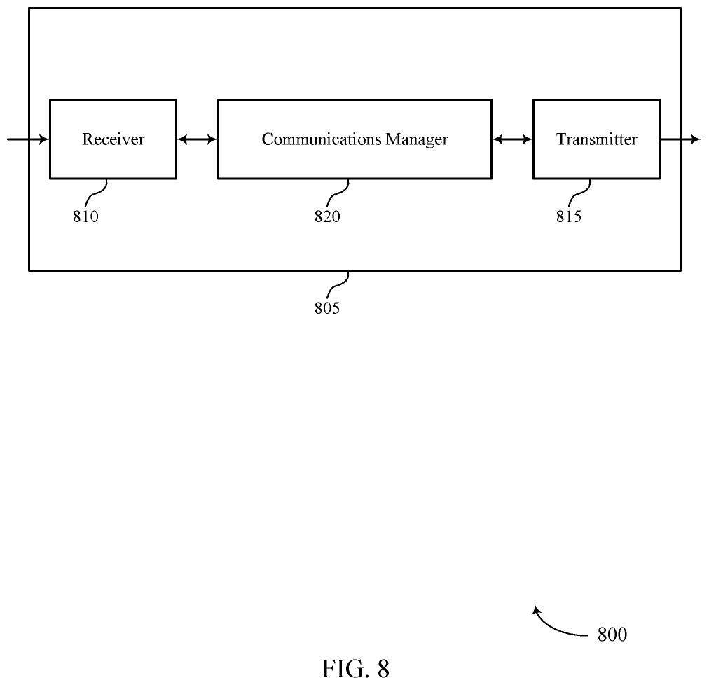

FIG. 8 shows a block diagram 800 of a device 805 that supports techniques for adaptive quantization level selection in federated learning in accordance with aspects of the present disclosure. The device 805 may be an example of aspects of a base station 105 or a server or both as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for adaptive quantization level selection in federated learning). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for adaptive quantization level selection in federated learning). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for adaptive quantization level selection in federated learning as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a base station or a server or both in accordance with examples as disclosed herein. For example, the communications manager 820 may be configured as or otherwise support a means for determining, for a UE of a set of UEs, a quantization level for gradient data output by a machine learning model implemented by the UE. The communications manager 820 may be configured as or otherwise support a means for transmitting, to the UE, first information for updating parameters of the machine learning model and an indication of the quantization level for the gradient data output by the machine learning model. The communications manager 820 may be configured as or otherwise support a means for receiving, from the UE, compressed gradient data based on the transmitting of the first information and the indication of the quantization level.

By including or configuring the communications manager 820 in accordance with examples as described herein, the device 805 (e.g., a processor controlling or otherwise coupled to the receiver 810, the transmitter 815, the communications manager 820, or a combination thereof) may reduce processing resources and power consumption associated with federated learning procedures. For example, by adaptively transmitting an indication of a quantization level for compressing gradient data to a UE, the device 805 may reduce a time spent and a quantity of resources used to receive the compressed gradient data.

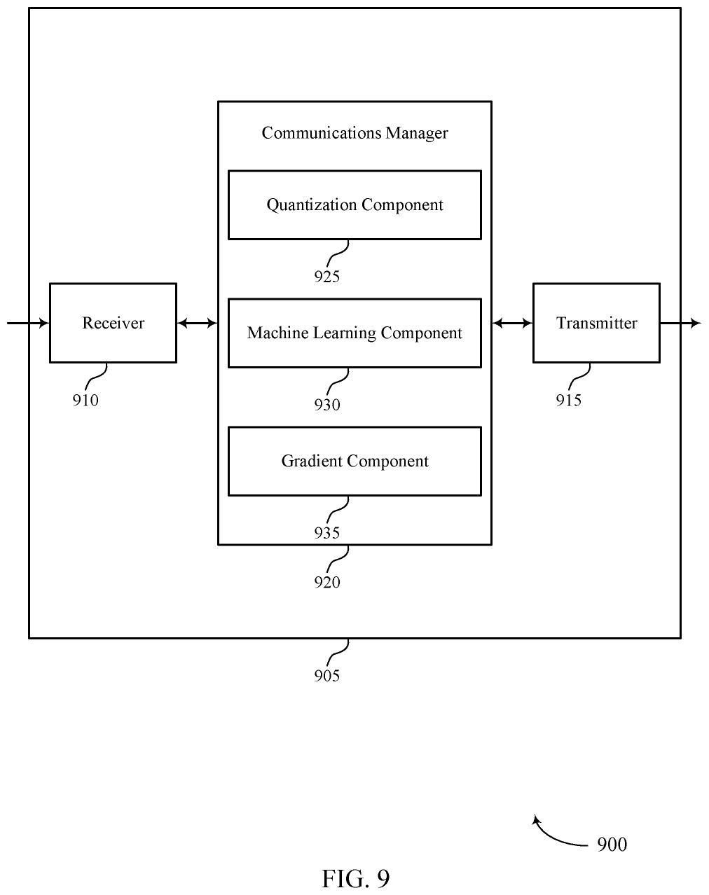

FIG. 9 shows a block diagram 900 of a device 905 that supports techniques for adaptive quantization level selection in federated learning in accordance with aspects of the present disclosure. The device 905 may be an example of aspects of a device 805 or a base station 105 or a server or both as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for adaptive quantization level selection in federated learning). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for adaptive quantization level selection in federated learning). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for adaptive quantization level selection in federated learning as described herein. For example, the communications manager 920 may include a quantization component 925, a machine learning component 930, a gradient component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station or a server or both in accordance with examples as disclosed herein. The quantization component 925 may be configured as or otherwise support a means for determining, for a UE of a set of UEs, a quantization level for gradient data output by a machine learning model implemented by the UE. The machine learning component 930 may be configured as or otherwise support a means for transmitting, to the UE, first information for updating parameters of the machine learning model and an indication of the quantization level for the gradient data output by the machine learning model. The gradient component 935 may be configured as or otherwise support a means for receiving, from the UE, compressed gradient data based on the transmitting of the first information and the indication of the quantization level.

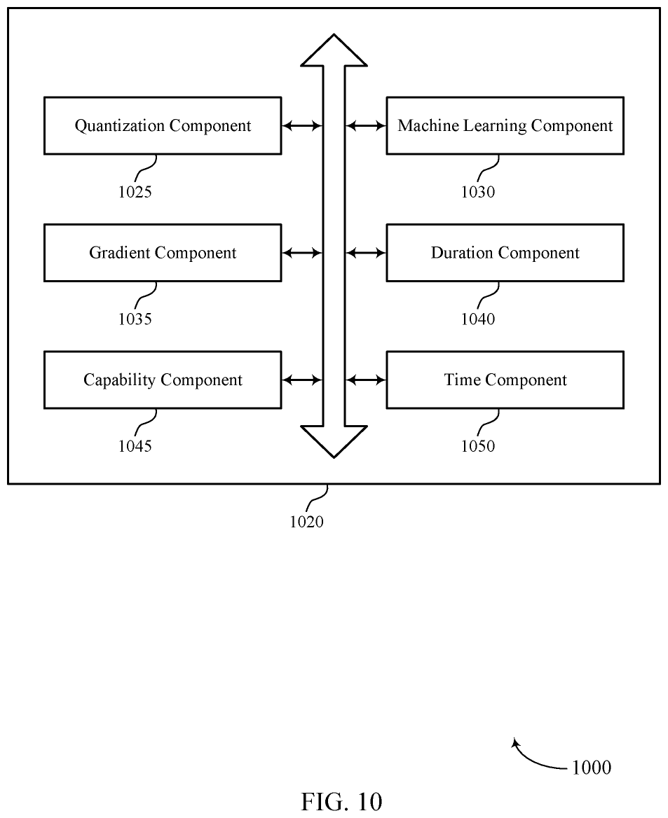

FIG. 10 shows a block diagram 1000 of a communications manager 1020 that supports techniques for adaptive quantization level selection in federated learning in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for adaptive quantization level selection in federated learning as described herein. For example, the communications manager 1020 may include a quantization component 1025, a machine learning component 1030, a gradient component 1035, a duration component 1040, a capability component 1045, a time component 1050, or any combination thereof. Each of these components may communicate, directly or indirectly, with one another (e.g., via one or more buses).

The communications manager 1020 may support wireless communication at a base station or a server or both in accordance with examples as disclosed herein. The quantization component 1025 may be configured as or otherwise support a means for determining, for a UE of a set of UEs, a quantization level for gradient data output by a machine learning model implemented by the UE. The machine learning component 1030 may be configured as or otherwise support a means for transmitting, to the UE, first information for updating parameters of the machine learning model and an indication of the quantization level for the gradient data output by the machine learning model. The gradient component 1035 may be configured as or otherwise support a means for receiving, from the UE, compressed gradient data based on the transmitting of the first information and the indication of the quantization level.

In some examples, the duration component 1040 may be configured as or otherwise support a means for calculating a duration associated with the communicating of the compressed gradient data. In some examples, the quantization component 1025 may be configured as or otherwise support a means for determining a second quantization level for second gradient data output by the machine learning model based on the duration satisfying a threshold duration. In some examples, the machine learning component 1030 may be configured as or otherwise support a means for transmitting, to the UE, second information for updating the parameters of the machine learning model and a second indication of the second quantization level. In some examples, the gradient component 1035 may be configured as or otherwise support a means for receiving, from the UE, second compressed gradient data based on the transmitting of the second information and the second indication of the second quantization level.

In some examples, the duration corresponds to a duration between transmitting the first information and receiving the compressed gradient data.

In some examples, the quantization level is common the set of UEs. In some examples, the second quantization level is specific to the UE.

In some examples, the capability component 1045 may be configured as or otherwise support a means for receiving, from the UE, a capability message indicating a set of quantization levels supported by the UE, where the set of quantization levels includes the quantization level for the gradient data output by the machine learning model.

In some examples, the machine learning component 1030 may be configured as or otherwise support a means for transmitting, to each UE of the set of UEs, the first information and a respective indication of a respective quantization level for respective gradient data output by the machine learning model. In some examples, the gradient component 1035 may be configured as or otherwise support a means for receiving, from each UE of the set of UEs, respective compressed gradient data based on the transmitting of the first information and the respective indication of the respective quantization level.

In some examples, the machine learning component 1030 may be configured as or otherwise support a means for determining second information for updating the parameters of the machine learning model based on a mean of the respective compressed gradient data received from each UE.

In some examples, the machine learning component 1030 may be configured as or otherwise support a means for combining the respective gradient data received from each UE to update a machine learning model implemented by the base station or a server or both, where determining the second information is based on the combining of the respective gradient data.

In some examples, the time component 1050 may be configured as or otherwise support a means for receiving, from the UE, a second indication of a time at which the gradient data is output by the machine learning model. In some examples, the gradient component 1035 may be configured as or otherwise support a means for receiving a third indication of the quantization level used to compress the gradient data output by the machine learning model.

In some examples, to support receiving of the third indication of the quantization level, the gradient component 1035 may be configured as or otherwise support a means for receiving a set of quantization levels for the gradient data output by the machine learning model, each quantization level of the set of quantization levels associated with a dimensional parameter of a set of dimensional parameters associated with the gradient data output by the machine learning model.

In some examples, the quantization component 1025 may be configured as or otherwise support a means for transmitting, to the UE, a set of quantization levels that includes the quantization level, where the indication of the quantization level identifies the quantization level from the set of quantization levels that is for the UE.

In some examples, the quantization level is based on a bandwidth of a channel for transmitting the compressed gradient data, a link budget associated with the UE, or a combination thereof.

In some examples, In some examples, the machine learning model includes a federated learning model associated with the set of UEs. In some examples, each UE of the set of UEs is associated with a unique dataset of the machine learning model.

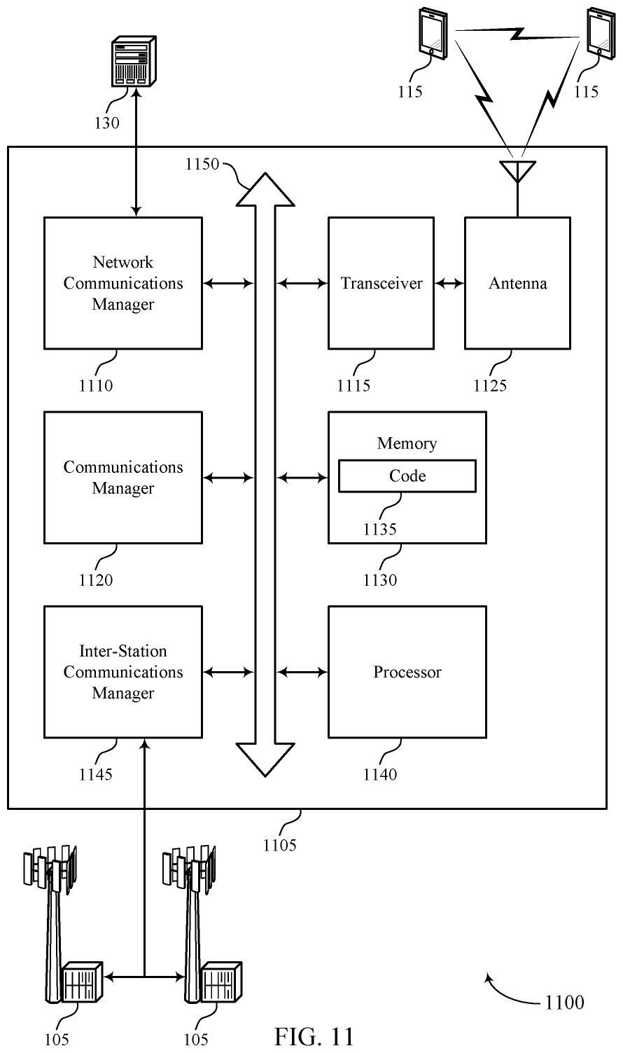

FIG. 11 shows a diagram of a system 1100 including a device 1105 that supports techniques for adaptive quantization level selection in federated learning in accordance with aspects of the present disclosure. The device 1105 may be an example of or include the components of a device 805, a device 905, or a base station 105 or a server or both as described herein. The device 1105 may communicate wirelessly with one or more base stations 105, UEs 115, servers, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for adaptive quantization level selection in federated learning). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with base stations 105, and may include a controller or scheduler for controlling communications with UEs 115 in cooperation with base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a base station or a server or both in accordance with examples as disclosed herein. For example, the communications manager 1120 may be configured as or otherwise support a means for determining, for a UE of a set of UEs, a quantization level for gradient data output by a machine learning model implemented by the UE. The communications manager 1120 may be configured as or otherwise support a means for transmitting, to the UE, first information for updating parameters of the machine learning model and an indication of the quantization level for the gradient data output by the machine learning model. The communications manager 1120 may be configured as or otherwise support a means for receiving, from the UE, compressed gradient data based on the transmitting of the first information and the indication of the quantization level.

By including or configuring the communications manager 1120 in accordance with examples as described herein, the device 1105 may provide improvements to federated learning techniques. For example, transmitting indications of quantization levels for compressing gradient data may ensure convergence to a global optima of a global machine learning model and may reduce latency associated with training the global machine learning model using federated learning techniques. Additionally, transmitting indications of quantization levels for compressing gradient data may promote improvements to efficiency and resource usage of federated learning operations and, in some examples, may promote spectral efficiency, reduce power consumption, improve coordination between the UE and the device 1105, and increase battery life, among other benefits.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for adaptive quantization level selection in federated learning as described herein, or the processor 1140 and the memory 1130 may be otherwise configured to perform or support such operations.

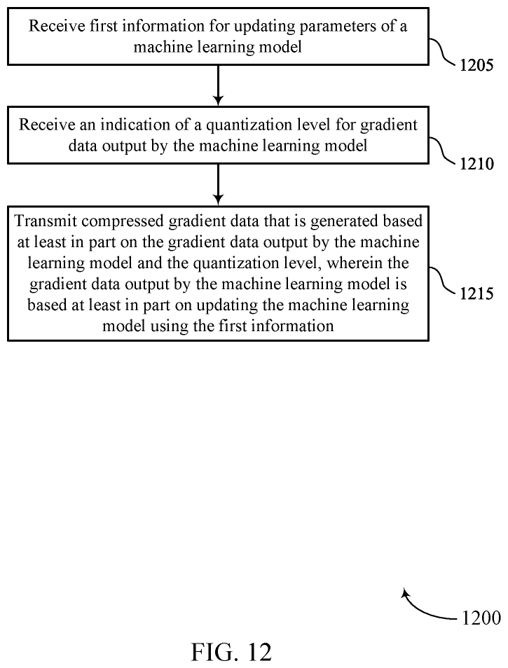

FIG. 12 shows a flowchart illustrating a method 1200 that supports techniques for adaptive quantization level selection in federated learning in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving first information for updating parameters of a machine learning model. The operations of 1205 may be performed in accordance with examples as disclosed herein. In some examples, aspects of the operations of 1205 may be performed by a parameter component 625 as described with reference to FIG. 6.

At 1210, the method may include receiving an indication of a quantization level for gradient data output by the machine learning model. The operations of 1210 may be performed in accordance with examples as disclosed herein. In some examples, aspects of the operations of 1210 may be performed by a quantization component 630 as described with reference to FIG. 6.

At 1215, the method may include transmitting compressed gradient data that is generated based on the gradient data output by the machine learning model and the quantization level, where the gradient data output by the machine learning model is based on updating the machine learning model using the first information. The operations of 1215 may be performed in accordance with examples as disclosed herein. In some examples, aspects of the operations of 1215 may be performed by a gradient component 635 as described with reference to FIG. 6.

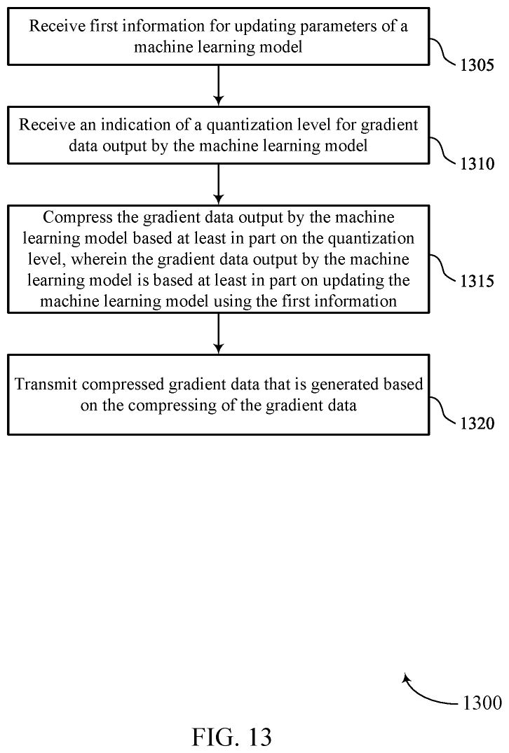

FIG. 13 shows a flowchart illustrating a method 1300 that supports techniques for adaptive quantization level selection in federated learning in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving first information for updating parameters of a machine learning model. The operations of 1305 may be performed in accordance with examples as disclosed herein. In some examples, aspects of the operations of 1305 may be performed by a parameter component 625 as described with reference to FIG. 6.

At 1310, the method may include receiving an indication of a quantization level for gradient data output by the machine learning model. The operations of 1310 may be performed in accordance with examples as disclosed herein. In some examples, aspects of the operations of 1310 may be performed by a quantization component 630 as described with reference to FIG. 6.

At 1315, the method may include compressing the gradient data output by the machine learning model based on the quantization level, where the gradient data output by the machine learning model is based on updating the machine learning model using the first information. The operations of 1315 may be performed in accordance with examples as disclosed herein. In some examples, aspects of the operations of 1315 may be performed by a compression component 640 as described with reference to FIG. 6.

At 1320, the method may include transmitting compressed gradient data that is generated based on the compressing of the gradient data. The operations of 1320 may be performed in accordance with examples as disclosed herein. In some examples, aspects of the operations of 1320 may be performed by a gradient component 635 as described with reference to FIG. 6.

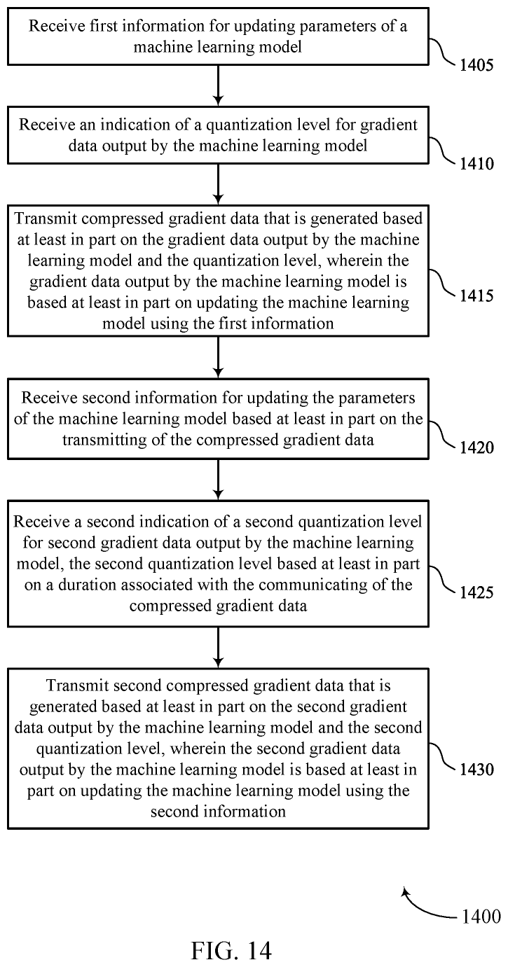

FIG. 14 shows a flowchart illustrating a method 1400 that supports techniques for adaptive quantization level selection in federated learning in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving first information for updating parameters of a machine learning model. The operations of 1405 may be performed in accordance with examples as disclosed herein. In some examples, aspects of the operations of 1405 may be performed by a parameter component 625 as described with reference to FIG. 6.

At 1410, the method may include receiving an indication of a quantization level for gradient data output by the machine learning model. The operations of 1410 may be performed in accordance with examples as disclosed herein. In some examples, aspects of the operations of 1410 may be performed by a quantization component 630 as described with reference to FIG. 6.

At 1415, the method may include transmitting compressed gradient data that is generated based on the gradient data output by the machine learning model and the quantization level, where the gradient data output by the machine learning model is based on updating the machine learning model using the first information. The operations of 1415 may be performed in accordance with examples as disclosed herein. In some examples, aspects of the operations of 1415 may be performed by a gradient component 635 as described with reference to FIG. 6.

At 1420, the method may include receiving second information for updating the parameters of the machine learning model based on the transmitting of the compressed gradient data. The operations of 1420 may be performed in accordance with examples as disclosed herein. In some examples, aspects of the operations of 1420 may be performed by a parameter component 625 as described with reference to FIG. 6.

At 1425, the method may include receiving a second indication of a second quantization level for second gradient data output by the machine learning model, the second quantization level based on a duration associated with the communicating of the compressed gradient data. The operations of 1425 may be performed in accordance with examples as disclosed herein. In some examples, aspects of the operations of 1425 may be performed by a quantization component 630 as described with reference to FIG. 6.

At 1430, the method may include transmitting second compressed gradient data that is generated based on the second gradient data output by the machine learning model and the second quantization level, where the second gradient data output by the machine learning model is based on updating the machine learning model using the second information. The operations of 1430 may be performed in accordance with examples as disclosed herein. In some examples, aspects of the operations of 1430 may be performed by a gradient component 635 as described with reference to FIG. 6.

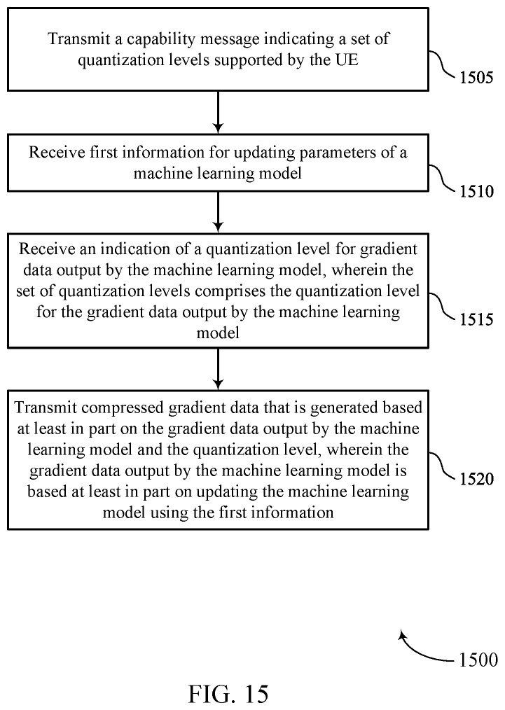

FIG. 15 shows a flowchart illustrating a method 1500 that supports techniques for adaptive quantization level selection in federated learning in accordance with aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1505, the method may include transmitting a capability message indicating a set of quantization levels supported by the UE. The operations of 1505 may be performed in accordance with examples as disclosed herein. In some examples, aspects of the operations of 1505 may be performed by a capability component 645 as described with reference to FIG. 6.

At 1510, the method may include receiving first information for updating parameters of a machine learning model. The operations of 1510 may be performed in accordance with examples as disclosed herein. In some examples, aspects of the operations of 1510 may be performed by a parameter component 625 as described with reference to FIG. 6.

At 1515, the method may include receiving an indication of a quantization level for gradient data output by the machine learning model, where the set of quantization levels includes the quantization level for the gradient data output by the machine learning model. The operations of 1515 may be performed in accordance with examples as disclosed herein. In some examples, aspects of the operations of 1515 may be performed by a quantization component 630 as described with reference to FIG. 6.

At 1520, the method may include transmitting compressed gradient data that is generated based on the gradient data output by the machine learning model and the quantization level, where the gradient data output by the machine learning model is based on updating the machine learning model using the first information. The operations of 1520 may be performed in accordance with examples as disclosed herein. In some examples, aspects of the operations of 1520 may be performed by a gradient component 635 as described with reference to FIG. 6.

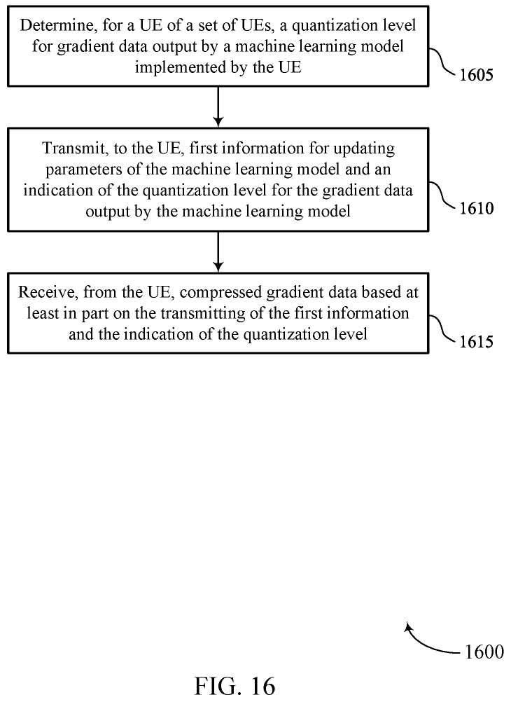

FIG. 16 shows a flowchart illustrating a method 1600 that supports techniques for adaptive quantization level selection in federated learning in accordance with aspects of the present disclosure. The operations of the method 1600 may be implemented by a base station or a server or both or its components as described herein. For example, the operations of the method 1600 may be performed by a base station 105 or a server or both as described with reference to FIGS. 1 through 3 and 8 through 11. In some examples, a base station or a server or both may execute a set of instructions to control the functional elements of the base station or a server or both to perform the described functions. Additionally or alternatively, the base station or a server or both may perform aspects of the described functions using special-purpose hardware.

At 1605, the method may include determining, for a UE of a set of UEs, a quantization level for gradient data output by a machine learning model implemented by the UE. The operations of 1605 may be performed in accordance with examples as disclosed herein. In some examples, aspects of the operations of 1605 may be performed by a quantization component 1025 as described with reference to FIG. 10.

At 1610, the method may include transmitting, to the UE, first information for updating parameters of the machine learning model and an indication of the quantization level for the gradient data output by the machine learning model. The operations of 1610 may be performed in accordance with examples as disclosed herein. In some examples, aspects of the operations of 1610 may be performed by a machine learning component 1030 as described with reference to FIG. 10.

At 1615, the method may include receiving, from the UE, compressed gradient data based on the transmitting of the first information and the indication of the quantization level. The operations of 1615 may be performed in accordance with examples as disclosed herein. In some examples, aspects of the operations of 1615 may be performed by a gradient component 1035 as described with reference to FIG. 10.

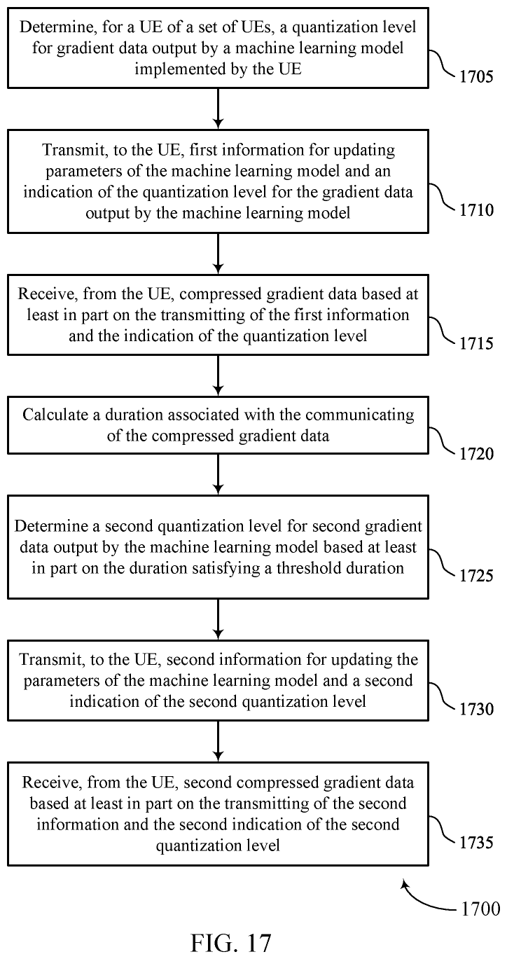

FIG. 17 shows a flowchart illustrating a method 1700 that supports techniques for adaptive quantization level selection in federated learning in accordance with aspects of the present disclosure. The operations of the method 1700 may be implemented by a base station or a server or both or its components as described herein. For example, the operations of the method 1700 may be performed by a base station 105 or a server or both as described with reference to FIGS. 1 through 3 and 8 through 11. In some examples, a base station or a server or both may execute a set of instructions to control the functional elements of the base station or a server or both to perform the described functions. Additionally or alternatively, the base station or a server or both may perform aspects of the described functions using special-purpose hardware.

At 1705, the method may include determining, for a UE of a set of UEs, a quantization level for gradient data output by a machine learning model implemented by the UE. The operations of 1705 may be performed in accordance with examples as disclosed herein. In some examples, aspects of the operations of 1705 may be performed by a quantization component 1025 as described with reference to FIG. 10.

At 1710, the method may include transmitting, to the UE, first information for updating parameters of the machine learning model and an indication of the quantization level for the gradient data output by the machine learning model. The operations of 1710 may be performed in accordance with examples as disclosed herein. In some examples, aspects of the operations of 1710 may be performed by a machine learning component 1030 as described with reference to FIG. 10.

At 1715, the method may include receiving, from the UE, compressed gradient data based on the transmitting of the first information and the indication of the quantization level. The operations of 1715 may be performed in accordance with examples as disclosed herein. In some examples, aspects of the operations of 1715 may be performed by a gradient component 1035 as described with reference to FIG. 10.

At 1720, the method may include calculating a duration associated with the communicating of the compressed gradient data. The operations of 1720 may be performed in accordance with examples as disclosed herein. In some examples, aspects of the operations of 1720 may be performed by a duration component 1040 as described with reference to FIG. 10.

At 1725, the method may include determining a second quantization level for second gradient data output by the machine learning model based on the duration satisfying a threshold duration. The operations of 1725 may be performed in accordance with examples as disclosed herein. In some examples, aspects of the operations of 1725 may be performed by a quantization component 1025 as described with reference to FIG. 10.

At 1730, the method may include transmitting, to the UE, second information for updating the parameters of the machine learning model and a second indication of the second quantization level. The operations of 1730 may be performed in accordance with examples as disclosed herein. In some examples, aspects of the operations of 1730 may be performed by a machine learning component 1030 as described with reference to FIG. 10.

At 1735, the method may include receiving, from the UE, second compressed gradient data based on the transmitting of the second information and the second indication of the second quantization level. The operations of 1735 may be performed in accordance with examples as disclosed herein. In some examples, aspects of the operations of 1735 may be performed by a gradient component 1035 as described with reference to FIG. 10.

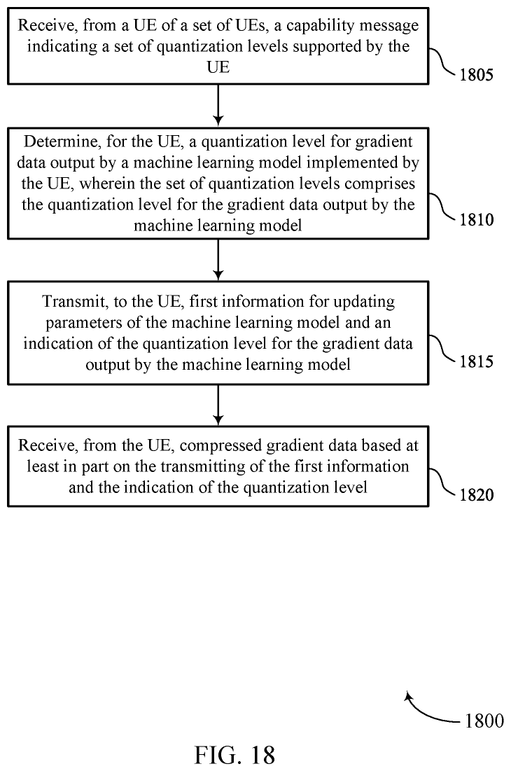

FIG. 18 shows a flowchart illustrating a method 1800 that supports techniques for adaptive quantization level selection in federated learning in accordance with aspects of the present disclosure. The operations of the method 1800 may be implemented by a base station or a server or both or its components as described herein. For example, the operations of the method 1800 may be performed by a base station 105 or a server or both as described with reference to FIGS. 1 through 3 and 8 through 11. In some examples, a base station or a server or both may execute a set of instructions to control the functional elements of the base station or a server or both to perform the described functions. Additionally or alternatively, the base station or a server or both may perform aspects of the described functions using special-purpose hardware.

At 1805, the method may include receiving, from a UE of a set of UEs, a capability message indicating a set of quantization levels supported by the UE. The operations of 1805 may be performed in accordance with examples as disclosed herein. In some examples, aspects of the operations of 1805 may be performed by a capability component 1045 as described with reference to FIG. 10.

At 1810, the method may include determining, for the UE, a quantization level for gradient data output by a machine learning model implemented by the UE, where the set of quantization levels includes the quantization level for the gradient data output by the machine learning model. The operations of 1810 may be performed in accordance with examples as disclosed herein. In some examples, aspects of the operations of 1810 may be performed by a quantization component 1025 as described with reference to FIG. 10.

At 1815, the method may include transmitting, to the UE, first information for updating parameters of the machine learning model and an indication of the quantization level for the gradient data output by the machine learning model. The operations of 1815 may be performed in accordance with examples as disclosed herein. In some examples, aspects of the operations of 1815 may be performed by a machine learning component 1030 as described with reference to FIG. 10.

At 1820, the method may include receiving, from the UE, compressed gradient data based on the transmitting of the first information and the indication of the quantization level. The operations of 1820 may be performed in accordance with examples as disclosed herein. In some examples, aspects of the operations of 1820 may be performed by a gradient component 1035 as described with reference to FIG. 10.

The following provides an overview of aspects of the present disclosure:

Aspect 1: A method for wireless communication at a UE, comprising: receiving first information for updating parameters of a machine learning model; receiving an indication of a quantization level for gradient data output by the machine learning model; and transmitting compressed gradient data that is generated based at least in part on the gradient data output by the machine learning model and the quantization level, wherein the gradient data output by the machine learning model is based at least in part on updating the machine learning model using the first information.

Aspect 2: The method of aspect 1, further comprising: compressing the gradient data output by the machine learning model based at least in part on the quantization level, wherein the transmitting of the compressed gradient data is based at least in part on the compressing of the gradient data.

Aspect 3: The method of any of aspects 1 through 2, further comprising: receiving second information for updating the parameters of the machine learning model based at least in part on the transmitting of the compressed gradient data; receiving a second indication of a second quantization level for second gradient data output by the machine learning model, the second quantization level based at least in part on a duration associated with the communicating of the compressed gradient data; and transmitting second compressed gradient data that is generated based at least in part on the second gradient data output by the machine learning model and the second quantization level, wherein the second gradient data output by the machine learning model is based at least in part on updating the machine learning model using the second information.

Aspect 4: The method of aspect 3, wherein the quantization level is associated with a set of UEs that includes the UE; and the second quantization level is specific to the UE.

Aspect 5: The method of any of aspects 1 through 4, further comprising: transmitting a capability message indicating a set of quantization levels supported by the UE, wherein the set of quantization levels comprises the quantization level for the gradient data output by the machine learning model.

Aspect 6: The method of any of aspects 1 through 5, further comprising: transmitting a second indication of a time at which the gradient data is output by the machine learning model; and transmitting a third indication of the quantization level used to compress the gradient data output by the machine learning model.

Aspect 7: The method of aspect 6, wherein the transmitting of the third indication of the quantization level comprises: transmitting a set of quantization levels for the gradient data output by the machine learning model, each quantization level of the set of quantization levels associated with a dimensional parameter of a set of dimensional parameters associated with the gradient data output by the machine learning model.

Aspect 8: The method of any of aspects 1 through 7, further comprising: receiving a set of quantization levels that includes the quantization level, wherein the indication of the quantization level identifies the quantization level from the set of quantization levels that is for the UE.

Aspect 9: The method of any of aspects 1 through 8, wherein the quantization level is based at least in part on a bandwidth of a channel for transmitting the compressed gradient data, a link budget associated with the UE, or a combination thereof.

Aspect 10: The method of any of aspects 1 through 9, wherein the machine learning model comprises a federated learning model associated with a set of UEs including the UE, and each UE of the set of UEs is associated with a unique dataset of the machine learning model.

Aspect 11: A method for wireless communication at a server, comprising: determining, for a UE of a set of UEs, a quantization level for gradient data output by a machine learning model implemented by the UE; transmitting, to the UE, first information for updating parameters of the machine learning model and an indication of the quantization level for the gradient data output by the machine learning model; and receiving, from the UE, compressed gradient data based at least in part on the transmitting of the first information and the indication of the quantization level.

Aspect 12: The method of aspect 11, further comprising: calculating a duration associated with the communicating of the compressed gradient data; determining a second quantization level for second gradient data output by the machine learning model based at least in part on the duration satisfying a threshold duration; transmitting, to the UE, second information for updating the parameters of the machine learning model and a second indication of the second quantization level; and receiving, from the UE, second compressed gradient data based at least in part on the transmitting of the second information and the second indication of the second quantization level.

Aspect 13: The method of aspect 12, wherein the duration corresponds to a second duration between transmitting the first information and receiving the compressed gradient data.

Aspect 14: The method of any of aspects 12 through 13, wherein the quantization level is common the set of UEs; and the second quantization level is specific to the UE.

Aspect 15: The method of any of aspects 11 through 14, further comprising: receiving, from the UE, a capability message indicating a set of quantization levels supported by the UE, wherein the set of quantization levels comprises the quantization level for the gradient data output by the machine learning model.

Aspect 16: The method of any of aspects 11 through 15, further comprising: transmitting, to each UE of the set of UEs, the first information and a respective indication of a respective quantization level for respective gradient data output by the machine learning model; and receiving, from each UE of the set of UEs, respective compressed gradient data based at least in part on the transmitting of the first information and the respective indication of the respective quantization level.

Aspect 17: The method of aspect 16, further comprising: determining second information for updating the parameters of the machine learning model based at least in part on a mean of the respective compressed gradient data received from each UE.

Aspect 18: The method of aspect 17, further comprising: combining the respective gradient data received from each UE to update a global machine learning model implemented by the server, wherein determining the second information is based at least in part on the combining of the respective gradient data.

Aspect 19: The method of any of aspects 11 through 18, further comprising: receiving, from the UE, a second indication of a time at which the gradient data is output by the machine learning model; and receiving a third indication of the quantization level used to compress the gradient data output by the machine learning model.

Aspect 20: The method of aspect 19, wherein the receiving of the third indication of the quantization level comprises: receiving a set of quantization levels for the gradient data output by the machine learning model, each quantization level of the set of quantization levels associated with a dimensional parameter of a set of dimensional parameters associated with the gradient data output by the machine learning model.

Aspect 21: The method of any of aspects 11 through 20, further comprising: transmitting, to the UE, a set of quantization levels that includes the quantization level, wherein the indication of the quantization level identifies the quantization level from the set of quantization levels that is for the UE.

Aspect 22: The method of any of aspects 11 through 21, wherein the quantization level is based at least in part on a bandwidth of a channel for transmitting the compressed gradient data, a link budget associated with the UE, or a combination thereof.

Aspect 23: The method of any of aspects 11 through 22, wherein the machine learning model comprises a federated learning model associated with the set of UEs, and each UE of the set of UEs is associated with a unique dataset of the machine learning model.

Aspect 24: An apparatus for wireless communication at a UE, comprising a processor; memory coupled with the processor; and instructions stored in the memory and executable by the processor to cause the apparatus to perform a method of any of aspects 1 through 10.

Aspect 25: An apparatus for wireless communication at a UE, comprising at least one means for performing a method of any of aspects 1 through 10.

Aspect 26: A non-transitory computer-readable medium storing code for wireless communication at a UE, the code comprising instructions executable by a processor to perform a method of any of aspects 1 through 10.

Aspect 27: An apparatus for wireless communication at a server, comprising a processor; memory coupled with the processor; and instructions stored in the memory and executable by the processor to cause the apparatus to perform a method of any of aspects 11 through 23.

Aspect 28: An apparatus for wireless communication at a server, comprising at least one means for performing a method of any of aspects 11 through 23.

Aspect 29: A non-transitory computer-readable medium storing code for wireless communication at a server, the code comprising instructions executable by a processor to perform a method of any of aspects 11 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving first information for updating parameters of a machine learning model;
receiving an indication of a quantization level for gradient data output by the machine learning model; and
transmitting compressed gradient data that is generated based at least in part on the gradient data output by the machine learning model and the quantization level, wherein the gradient data output by the machine learning model is based at least in part on updating the machine learning model using the first information.

2. The method of claim 1, further comprising:
compressing the gradient data output by the machine learning model based at least in part on the quantization level, wherein the transmitting of the compressed gradient data is based at least in part on the compressing of the gradient data.

3. The method of claim 1, further comprising:
receiving second information for updating the parameters of the machine learning model based at least in part on the transmitting of the compressed gradient data;
receiving a second indication of a second quantization level for second gradient data output by the machine learning model, the second quantization level based at least in part on a duration associated with the communicating of the compressed gradient data; and
transmitting second compressed gradient data that is generated based at least in part on the second gradient data output by the machine learning model and the second quantization level, wherein the second gradient data output by the machine learning model is based at least in part on updating the machine learning model using the second information.

4. The method of claim 3, wherein:
the quantization level is associated with a set of UEs that includes the UE; and
the second quantization level is specific to the UE.

5. The method of claim 1, further comprising:
transmitting a capability message indicating a set of quantization levels supported by the UE, wherein the set of quantization levels comprises the quantization level for the gradient data output by the machine learning model.

6. The method of claim 1, further comprising:
transmitting a second indication of a time at which the gradient data is output by the machine learning model; and
transmitting a third indication of the quantization level used to compress the gradient data output by the machine learning model.

7. The method of claim 6, wherein the transmitting of the third indication of the quantization level comprises:
transmitting a set of quantization levels for the gradient data output by the machine learning model, each quantization level of the set of quantization levels associated with a dimensional parameter of a set of dimensional parameters associated with the gradient data output by the machine learning model.

8. The method of claim 1, further comprising:
receiving a set of quantization levels that includes the quantization level, wherein the indication of the quantization level identifies the quantization level from the set of quantization levels that is for the UE.

9. The method of claim 1, wherein the quantization level is based at least in part on a bandwidth of a channel for transmitting the compressed gradient data, a link budget associated with the UE, or a combination thereof.

10. The method of claim 1, wherein the machine learning model comprises a federated learning model associated with a set of UEs including the UE, and wherein each UE of the set of UEs is associated with a unique dataset of the machine learning model.

11. A method for wireless communication at a server, comprising:
determining, for a user equipment (UE) of a set of UEs, a quantization level for gradient data output by a machine learning model implemented by the UE;
transmitting, to the UE, first information for updating parameters of the machine learning model and an indication of the quantization level for the gradient data output by the machine learning model; and
receiving, from the UE, compressed gradient data based at least in part on the transmitting of the first information and the indication of the quantization level.

12. The method of claim 11, further comprising:
calculating a duration associated with the communicating of the compressed gradient data;
determining a second quantization level for second gradient data output by the machine learning model based at least in part on the duration satisfying a threshold duration;
transmitting, to the UE, second information for updating the parameters of the machine learning model and a second indication of the second quantization level; and
receiving, from the UE, second compressed gradient data based at least in part on the transmitting of the second information and the second indication of the second quantization level.

13. The method of claim 12, wherein the duration corresponds to a second duration between transmitting the first information and receiving the compressed gradient data.

14. The method of claim 12, wherein:
the quantization level is common the set of UEs; and
the second quantization level is specific to the UE.

15. The method of claim 11, further comprising:
receiving, from the UE, a capability message indicating a set of quantization levels supported by the UE, wherein the set of quantization levels comprises the quantization level for the gradient data output by the machine learning model.

16. The method of claim 11, further comprising:
transmitting, to each UE of the set of UEs, the first information and a respective indication of a respective quantization level for respective gradient data output by the machine learning model; and
receiving, from each UE of the set of UEs, respective compressed gradient data based at least in part on the transmitting of the first information and the respective indication of the respective quantization level.

17. The method of claim 16, further comprising:
determining second information for updating the parameters of the machine learning model based at least in part on a mean of the respective compressed gradient data received from each UE.

18. The method of claim 17, further comprising:
combining the respective gradient data received from each UE to update a global machine learning model implemented by the server, wherein determining the second information is based at least in part on the combining of the respective gradient data.

19. The method of claim 11, further comprising:
receiving, from the UE, a second indication of a time at which the gradient data is output by the machine learning model; and
receiving a third indication of the quantization level used to compress the gradient data output by the machine learning model.

20. The method of claim 19, wherein the receiving of the third indication of the quantization level comprises:
receiving a set of quantization levels for the gradient data output by the machine learning model, each quantization level of the set of quantization levels associated with a dimensional parameter of a set of dimensional parameters associated with the gradient data output by the machine learning model.

21. The method of claim 11, further comprising:
transmitting, to the UE, a set of quantization levels that includes the quantization level, wherein the indication of the quantization level identifies the quantization level from the set of quantization levels that is for the UE.

22. The method of claim 11, wherein the quantization level is based at least in part on a bandwidth of a channel for transmitting the compressed gradient data, a link budget associated with the UE, or a combination thereof.

23. The method of claim 11, wherein the machine learning model comprises a federated learning model associated with the set of UEs, and wherein each UE of the set of UEs is associated with a unique dataset of the machine learning model.

24. An apparatus for wireless communication at a user equipment (UE), comprising:
a processor;
memory coupled with the processor; and
instructions stored in the memory and executable by the processor to cause the apparatus to:
receive first information for updating parameters of a machine learning model;
receive an indication of a quantization level for gradient data output by the machine learning model; and
transmit compressed gradient data that is generated based at least in part on the gradient data output by the machine learning model and the quantization level, wherein the gradient data output by the machine learning model is based at least in part on updating the machine learning model using the first information.

25. The apparatus of claim 24, wherein the instructions are further executable by the processor to cause the apparatus to:
compress the gradient data output by the machine learning model based at least in part on the quantization level, wherein the transmitting of the compressed gradient data is based at least in part on the compressing of the gradient data.

26. The apparatus of claim 24, wherein the instructions are further executable by the processor to cause the apparatus to:
receive second information for updating the parameters of the machine learning model based at least in part on the transmitting of the compressed gradient data;
receive a second indication of a second quantization level for second gradient data output by the machine learning model, the second quantization level based at least in part on a duration associated with the communicating of the compressed gradient data; and
transmit second compressed gradient data that is generated based at least in part on the second gradient data output by the machine learning model and the second quantization level.

27. The apparatus of claim 24, wherein the instructions are further executable by the processor to cause the apparatus to:
transmit a capability message indicating a set of quantization levels supported by the UE, wherein the set of quantization levels comprises the quantization level for the gradient data output by the machine learning model.

28. An apparatus for wireless communication at a server, comprising:
a processor;
memory coupled with the processor; and
instructions stored in the memory and executable by the processor to cause the apparatus to:
determine, for a user equipment (UE) of a set of UEs, a quantization level for gradient data output by a machine learning model that is communicated by the UE;
transmit, to the UE, first information for updating parameters of the machine learning model and an indication of the quantization level for the gradient data output by the machine learning model; and
receive, from the UE, compressed gradient data based at least in part on the transmitting of the first information and the indication of the quantization level.

29. The apparatus of claim 28, wherein the instructions are further executable by the processor to cause the apparatus to:
calculate a duration associated with the communicating of the compressed gradient data;
determine a second quantization level for second gradient data output by the machine learning model based at least in part on the duration satisfying a threshold duration;
transmit, to the UE, second information for updating the parameters of the machine learning model and a second indication of the second quantization level; and
receive, from the UE, second compressed gradient data based at least in part on the transmitting of the second information and the second indication of the second quantization level.

30. The apparatus of claim 28, wherein the instructions are further executable by the processor to cause the apparatus to:
receive, from the UE, a capability message indicating a set of quantization levels supported by the UE, wherein the set of quantization levels comprises the quantization level for the gradient data output by the machine learning model.
